(19) United States
(12) Patent Application Publication
(10) Pub. No.: US 2010/0283979 A1
(43) Pub. Date: Nov. 11, 2010

(54) Exposure apparatus, exposing method, and device fabricating method

(75) Inventors: Katsushi Nakano, Kumagaya-shi (JP); Munetaka Sugimoto, Kumagaya-shi (JP); Shigeru Aoki, Portland, OR (US); Shin Hirokawa, Fukaya-shi (JP)

Correspondence Address: OLIFF & BERRIDGE, PLC, P.O. BOX 320850, ALEXANDRIA, VA, 22320-4850, US

(73) Assignee: NIKON CORPORATION, TOKYO (JP)

(21) Appl. No.: 12/588,875

(22) Filed: Oct. 30, 2009

Related U.S. Application Data
(60) Provisional application No. 61/193,286, filed on Nov. 13, 2008.

(30) Foreign Application Priority Data
Oct. 31, 2008 (JP) 2008-281809

(51) Int. Cl. G03B 27/52

(52) U.S. Cl. 355/30

(57) ABSTRACT

An exposure apparatus successively exposes each substrate of a plurality of substrates included in a lot with exposure light through a liquid. The exposure apparatus comprises: a movable substrate holding member that holds the substrate at a position whereto the exposure light can be radiated; and a liquid immersion member that is capable of forming an immersion space such that the liquid is held between the liquid immersion member and the substrate held by the substrate holding member and an optical path of the exposure light is filled with the liquid; wherein, before the start of exposure of a first substrate in the lot, the immersion space is formed between the liquid immersion member and a movable member, which is different from the first substrate, and at least one of the liquid immersion member and the movable member is cleaned.

### CROSS-REFERENCE TO RELATED APPLICATION

This application is a non-provisional application claiming priority to and the benefit of U.S. provisional application No. 61/193,286, filed Nov. 13, 2008, and claims priority to Japanese Patent Application No. 2008-281809, filed Oct. 31, 2008. The contents of which are incorporated herein by reference.

### BACKGROUND

1. Field of the Invention

The present invention relates to an exposure apparatus, an exposing method, and a device fabricating method.

2. Description of Related Art

As disclosed in, for example in U.S. Pat. No. 7,292,313, among exposure apparatuses used in photolithography, an immersion exposure apparatus that exposes a substrate with exposure light through a liquid is known.

In immersion exposure apparatuses, members that contact the liquid might become contaminated. If, for example, foreign matter becomes adhered to a given member and that member is left in that state, such foreign matter might cause defects in the pattern formed on the substrate and, in turn, cause exposure failures. As a result, defective devices might be produced.

It is an object of the present invention to provide both an immersion exposure apparatus that can prevent exposure failures and an exposing method. Another object of the present invention is to provide a device fabricating method that can prevent defective devices from being produced.

### SUMMARY

A first aspect of the invention provides an exposure apparatus that successively exposes each substrate of a plurality of substrates included in a lot with exposure light through a liquid and comprises: a movable substrate holding member that holds the substrate at a position whereto the exposure light can be radiated; and a liquid immersion member that is capable of forming an immersion space such that the liquid is held between the liquid immersion member and the substrate held by the substrate holding member and an optical path of the exposure light is filled with the liquid; wherein, before the start of exposure of a first substrate in the lot, the immersion space is formed between the liquid immersion member and a movable member, which is different from the first substrate, and at least one of the liquid immersion member and the movable member is cleaned.

A second aspect of the invention provides an exposure apparatus that successively exposes each substrate of a plurality of substrates included in a lot with exposure light through a liquid and comprises: a movable substrate holding member that holds the substrate at a position whereto the exposure light can be radiated; and a liquid immersion member that is capable of forming an immersion space such that the liquid is held between the liquid immersion member and the substrate held by the substrate holding member and an optical path of the exposure light is filled with the liquid; wherein, after the end of exposure of a last substrate in the lot, the immersion space is formed between the liquid immersion member and a movable member, which is different from the last substrate, and at least one of the liquid immersion member and the movable member is cleaned.

A third aspect of the invention provides an exposure apparatus that successively exposes each substrate of a plurality of substrates included in a lot with exposure light through a liquid and comprises: a movable substrate holding member that holds the substrate at a position whereto the exposure light can be radiated; and a liquid immersion member that is capable of forming an immersion space such that the liquid is held between the liquid immersion member and the substrate held by the substrate holding member and an optical path of the exposure light is filled with the liquid; wherein, by moving the substrate holding member such that the immersion space is formed between the substrate held by the substrate holding member and the liquid immersion member and the immersion space is substantially not formed on an edge of the substrate held by the substrate holding member, the liquid immersion member is cleaned.

A fourth aspect of the invention provides a device fabricating method that comprises the steps of: exposing a substrate using an exposure apparatus according to any one aspect of the first through third aspects; and developing the exposed substrate.

A fifth aspect of the invention provides an exposing method that successively exposes each substrate of a plurality of substrates included in a lot with exposure light through a liquid and comprises the steps of: before the start of exposure of a first substrate in the lot, forming an immersion space between a movable member, which is different from the first substrate, and a liquid immersion member such that an optical path of the exposure light is filled with the liquid and cleaning at least one of the liquid immersion member and the movable member; and after the cleaning, forming the immersion space between the first substrate in the lot and the liquid immersion member such that the optical path of the exposure light is filled with the liquid and starting the exposure of the first substrate.

A sixth aspect of the invention provides an exposing method that successively exposes each substrate of a plurality of substrates included in a lot with exposure light through a liquid and comprises the steps of: forming an immersion space between a last substrate in the lot and a liquid immersion member such that an optical path of the exposure light is filled with the liquid and exposing the last substrate; and after the end of exposure of the last substrate, forming the immersion space between a movable member, which is different from the last substrate, and the liquid immersion member and cleaning at least one of the liquid immersion member and the movable member.

A seventh aspect of the invention provides a device fabricating method that comprises the steps of: exposing a substrate using an exposing method according to the fifth or sixth aspects; and developing the exposed substrate.

According to some aspects of the present invention, exposure failures are prevented from occurring. In addition, according to the present invention, it is possible to prevent the production of defective devices.

### BRIEF DESCRIPTION OF THE DRAWINGS

FIG. 1 is a schematic block diagram that shows one example of an exposure apparatus according to the first embodiment.

FIG. 2 is a plan view that schematically shows the exposure apparatus according to the first embodiment.

FIG. 3 is a side cross sectional view that shows one example of a substrate stage and a measurement stage according to the first embodiment.

FIG. 4 is a plan view that shows one example of a substrate held by the substrate stage according to the first embodiment.

FIG. 5 is a plan view that shows one example of the measurement stage according to the first embodiment.

FIG. 6 is a side cross sectional view that shows one example of the substrate according to the first embodiment.

FIG. 7 is a side cross sectional view that shows one example of a dummy substrate according to the first embodiment.

FIG. 8 is a side cross sectional view that shows one example of a liquid immersion member according to the first embodiment.

FIG. 9 is a schematic drawing for explaining one example of the operation of the exposure apparatus according to the first embodiment.

FIG. 10 is a flow chart for explaining one example of the operation of the exposure apparatus according to the first embodiment.

FIG. 11 is a schematic drawing for explaining one example of the operation of the exposure apparatus according to the first embodiment.

FIG. 12 is a schematic drawing for explaining one example of the operation of the exposure apparatus according to the first embodiment.

FIG. 13 is a schematic drawing for explaining one example of the operation of the exposure apparatus according to the first embodiment.

FIG. 14 is a schematic drawing that shows one example of a detection system according to the first embodiment.

FIG. 15 is a flow chart that shows one example of the operation of the exposure apparatus according to a second embodiment.

FIG. 16 is a schematic drawing for explaining one example of the operation of the exposure apparatus according to a third embodiment.

FIG. 17 is a schematic drawing for explaining one example of the operation of the exposure apparatus according to the third embodiment.

FIG. 18 is a schematic drawing for explaining one example of the operation of the exposure apparatus according to a fourth embodiment.

FIG. 19 is a schematic drawing for explaining one example of the operation of the exposure apparatus according to the fourth embodiment.

FIG. 20A presents schematic drawings for explaining one example of the operation of the exposure apparatus according to the fourth embodiment.

FIG. 20B presents schematic drawings for explaining one example of the operation of the exposure apparatus according to the fourth embodiment.

FIG. 21A presents schematic drawings for explaining one example of the operation of the exposure apparatus according to a fifth embodiment.

FIG. 21B presents schematic drawings for explaining one example of the operation of the exposure apparatus according to a fifth embodiment.

FIG. 22A presents schematic drawings for explaining one example of the operation of the exposure apparatus according to a sixth embodiment.

FIG. 22B presents schematic drawings for explaining one example of the operation of the exposure apparatus according to a sixth embodiment.

FIG. 23 is a plan view that shows one example of the measurement stage according to the sixth embodiment.

FIG. 24 is a flow chart for explaining one example of a microdevice fabricating process.

### DESCRIPTION OF EMBODIMENTS

The following text explains the embodiments of the present invention, referencing the drawings; however, the present invention is not limited thereto. The explanation below defines an XYZ orthogonal coordinate system, and the positional relationships among parts are explained referencing this system. Prescribed directions within the horizontal plane are the X axial directions, directions orthogonal to the X axial directions in the horizontal plane are the Y axial directions, and directions orthogonal to the X axial directions and the Y axial directions are the Z axial directions (i.e., the vertical directions). In addition, the rotational (i.e., inclinational) directions around the X, Y, and Z axes are the θX, θY, and θZ directions, respectively.

### First Embodiment

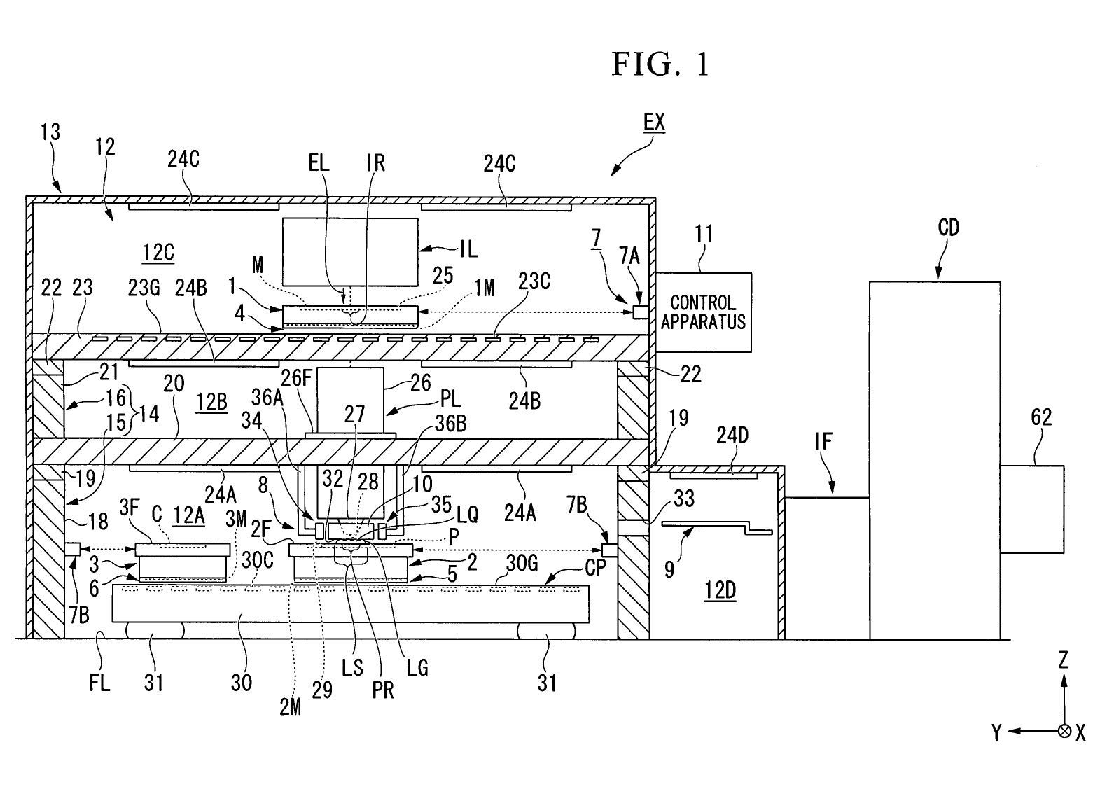

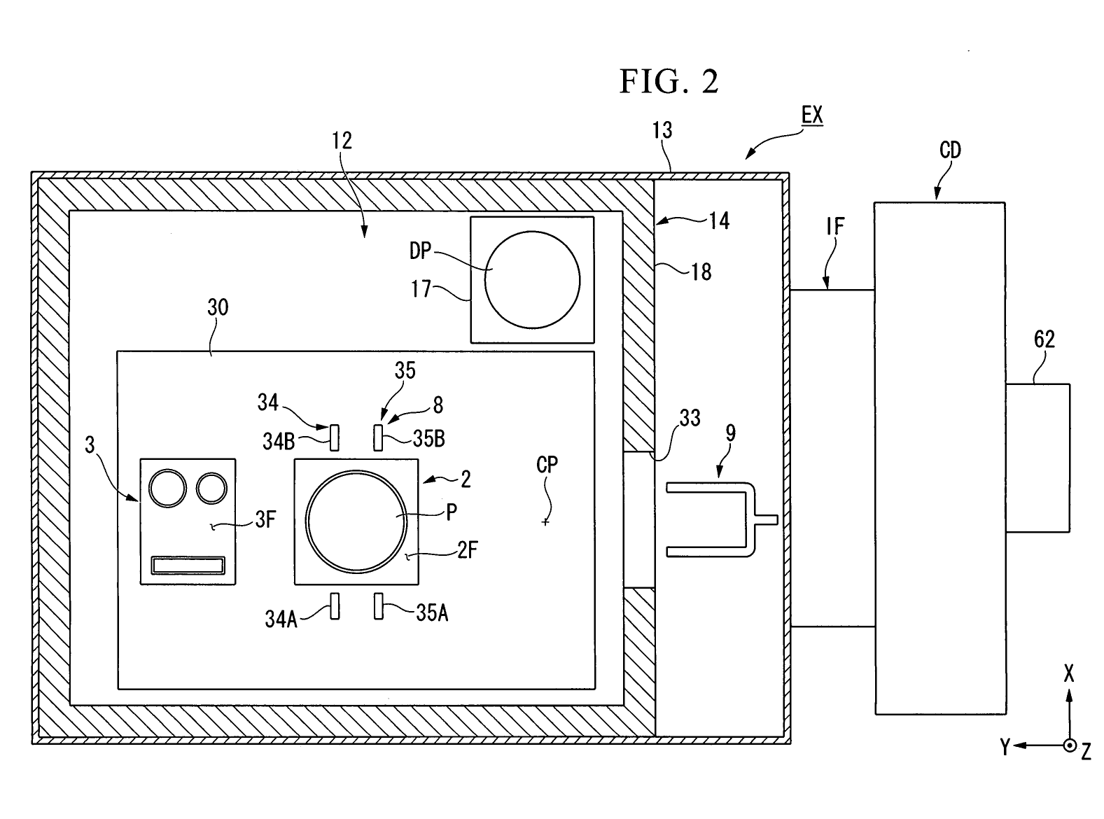

A first embodiment will now be explained. FIG. 1 is a schematic block drawing that shows one example of an exposure apparatus EX according to the first embodiment, and FIG. 2 is a plan view that schematically shows the exposure apparatus EX. The exposure apparatus EX of the present embodiment is an immersion exposure apparatus that exposes a substrate P with exposure light EL that passes through a liquid LQ. In the present embodiment, water (i.e., pure water) is used as the liquid LQ.

In the present embodiment, the exposure apparatus EX is connected to an external apparatus CD via an interface IF. In the present embodiment, the external apparatus CD may be a coating apparatus that forms a photosensitive film on the substrate P prior to exposure or a coating and developing apparatus that comprises a developing apparatus that develops the substrate P after exposure. The photosensitive film is made of a photosensitive material (e.g., photoresist). The substrate P is transported through the interface IF between the exposure apparatus EX and the external apparatus CD.

The exposure apparatus EX comprises: a movable mask stage 1, which holds a mask M; a movable substrate stage 2, which holds the substrate P; a movable measurement stage 3, which does not hold the substrate P and is equipped with measuring members C (i.e., measuring instruments) that measure the exposure light EL; a drive system 4, which moves the mask stage 1; a drive system 5, which moves the substrate stage 2; a drive system 6, which moves the measurement stage 3; an interferometer system 7, which measures the positions of the mask stage 1, the substrate stage 2, and the measurement stage 3; a detection system 8, which detects the position of the front surface of the substrate P held by the substrate stage 2; a transport apparatus 9, which is capable of transporting the substrate P; an illumination system IL, which illuminates the mask M with the exposure light EL; a projection optical system PL, which projects an image of a pattern of the mask M illuminated by the exposure light EL to the substrate P; a liquid immersion member 10, which is capable of forming an immersion space LS such that at least part of the optical path of the exposure light EL is filled with the liquid LQ; and a control apparatus 11, which controls the operation of the entire exposure apparatus EX.

The mask M comprises a reticle whereon a device pattern that is projected to the substrate P is formed. The mask M may be, for example, a transmissive mask that comprises a transparent plate made of glass or the like whereon a pattern is formed using a shielding material such as chrome. Furthermore, the mask M may alternatively be a reflective mask.

The substrate P is a substrate for fabricating devices. The substrate P comprises, for example, a base material, such as a semiconductor wafer, and a photosensitive film, which is formed on the base material.

In addition, the exposure apparatus EX comprises: a chamber apparatus 13, which forms an internal space 12; and a body 14, which is disposed in the internal space 12. The body 14 comprises a first column 15 and a second column 16, which is provided on the first column 15. In the present embodiment, the mask stage 1, the substrate stage 2, the measurement stage 3, the illumination system IL, the projection optical system PL, the transport apparatus 9, the body 14, and the like are disposed in the internal space 12 formed by the chamber apparatus 13. The exposure light EL travels through at least part of the internal space 12.

In addition, in the present embodiment, the exposure apparatus EX comprises a housing apparatus 17, which houses a dummy substrate DP. In the present embodiment, the housing apparatus 17 is disposed in the internal space 12. The dummy substrate DP has substantially the same external shape as the substrate P. In the present embodiment, the transport apparatus 9 is capable of transporting the dummy substrate DP.

The first column 15 comprises: a first support member 18; and a first base plate 20, which is supported by the first support member 18 via vibration isolating apparatuses 19. The second column 16 comprises: a second support member 21, which is disposed on the first base plate 20, and a second base plate 23, which is supported by the second support member 21 via vibration isolating apparatuses 22.

In the present embodiment, the internal space 12 includes substantially closed first, second, third, and fourth spaces 12A, 12B, 12C, 12D. In the present embodiment, the first space 12A includes at least part of the space between the first column 15 and a support surface FL, which is disposed in, for example, a clean room. In the present embodiment, the second space 12B includes at least part of the space between the second column 16 and the first base plate 20. In the present embodiment, the third space 12C includes at least part of the space between the chamber apparatus 13 and the second base plate 23. In the present embodiment, the fourth space 12D includes at least part of the space between the first column 15 (i.e., the first support member 18) and the chamber apparatus 13.

In addition, in the present embodiment, the exposure apparatus EX comprises a first environment adjusting apparatus 24A, a second environment adjusting apparatus 24B, a third environment adjusting apparatus 24C, a fourth environment adjusting apparatus 24D, which adjust the environments (comprising at least one of the members of the group consisting of the temperature, the humidity, the pressure, and the cleanliness level) of the first, second, third, and fourth spaces 12A, 12B, 12C, 12D. In the present embodiment, each of the environment adjusting apparatuses 24A-24D comprises: a temperature adjusting apparatus, which is capable of adjusting the temperature of a gas; a filter unit, which is capable of eliminating foreign matter from the gas; and the like. The first to fourth environment adjusting apparatuses 24A-24D adjust the environments of the first through fourth spaces 12A-12D by supplying gas that is clean and whose temperature has been adjusted. In the present embodiment, the temperature of the gas supplied by the environment adjusting apparatuses 24A-24D is, for example, 23° C.

The illumination system IL radiates the exposure light EL to a prescribed illumination region IR. The illumination region IR includes a position whereto the exposure light EL that emerges from the illumination system IL can be radiated. The illumination system IL illuminates at least part of the mask M disposed in the illumination region IR with the exposure light EL, which has a uniform luminous flux intensity distribution. Examples of light that can be used as the exposure light EL that emerges from the illumination system IL include: deep ultraviolet (DUV) light such as a bright line (i.e., g-line, h-line, or i-line) light emitted from, for example, a mercury lamp, and KrF excimer laser light (with a wavelength of 248 nm); and vacuum ultraviolet (VUV) light such as ArF excimer laser light (with a wavelength of 193 nm) and F₂ laser light (with a wavelength of 157 nm). In the present embodiment, ArF excimer laser light, which is ultraviolet light (e.g., vacuum ultraviolet light), is used as the exposure light EL.

The mask stage 1 is capable of moving inside the third space 12C in the state wherein it holds the mask M. The mask stage 1 is capable of moving on a guide surface 23G of the second base plate 23 with respect to the optical path of the exposure light EL. The mask stage 1 is capable of moving the mask M with respect to the illumination region IR (i.e., a position whereto the exposure light EL from the illumination system IL can be radiated) by the operation of the drive system 4. The mask stage 1 comprises a mask holding part 25 that releasably holds the mask M. In the present embodiment, the mask holding part 25 holds the mask M such that a front surface (i.e., a patterned surface) of the mask M is substantially parallel to the XY plane.

The mask stage 1 is capable of moving by the operation of the drive system 4. In the present embodiment, the drive system 4 comprises a planar motor for moving the mask stage 1 on the guide surface 23G. The planar motor for moving the mask stage 1 comprises a slider 1M, which is disposed on the mask stage 1, and stators 23C, which are disposed on the second base plate 23, as disclosed in, for example, U.S. Pat. No. 6,452,292. In the present embodiment, the mask stage 1 is capable of moving in six directions—that is, in the X, Y, and Z axial directions and the θX, θY, and θZ directions—by the operation of the drive system 4, which comprises planar motors.

The projection optical system PL radiates the exposure light EL to a prescribed projection region PR. The projection optical system PL projects with a prescribed projection magnification an image of the pattern of the mask M to at least the part of the substrate P that is disposed in the projection region PR. A lens barrel 26 holds the plurality of optical elements of the projection optical system PL. The lens barrel 26 has a flange 26F. The projection optical system PL is supported by the first base plate 20 via the flange 26F. Furthermore, a vibration isolating apparatus can be provided between the first base plate 20 and the lens barrel 26.

The projection optical system PL of the present embodiment is a reduction system that has a projection magnification of, for example, ¼, ⅕, or ⅛. Furthermore, the projection optical system PL may also be a unity magnification system or an enlargement system. In the present embodiment, the optical axis of the projection optical system PL is parallel to the Z axis. In addition, the projection optical system PL may be a dioptric system that does not include catoptric elements, a catoptric system that does not include dioptric elements, or a catadioptric system that includes both catoptric and dioptric elements. In addition, the projection optical system PL may form either an inverted or an erect image.

A last optical element 27 of the plurality of optical elements of the projection optical system PL that is closest to the image plane of the projection optical system PL has an emergent surface 28, wherefrom the exposure light EL emerges toward the image plane of the projection optical system PL. The projection region PR includes a position whereto the exposure light EL that emerges from the emergent surface 28 of the projection optical system PL (i.e., the last optical element 27) can be radiated.

In the present embodiment, at least the last optical element 27 of the plurality of optical elements of the projection optical system PL is disposed in the first space 12A. The optical path of the exposure light EL emerging from the emergent surface 28 of the last optical element 27 is disposed in the first space 12A. Namely, in the present embodiment, the first space 12A includes the optical path on the image plane side of the projection optical system PL and includes at least part of the optical path of the exposure light EL that impinges the substrate P.

The substrate stage 2 is capable of moving in the first space 12A in the state wherein it holds the substrate P. The substrate stage 2 comprises a first holding part 29, which releasably holds the substrate P. The substrate stage 2 is capable of moving with respect to the optical path of the exposure light EL. The substrate stage 2 is capable of moving the substrate P in the projection region PR (i.e., at a position whereto the exposure light EL from the projection optical system PL can be radiated) on a guide surface 30G.

The measurement stage 3 is capable of moving on the guide surface 30G with respect to the optical path of the exposure light EL in the first space 12A. The measurement stage 3 is equipped with the plurality of measuring members C (i.e., measuring instruments). The exposure light EL is radiated to at least one of the measuring members C.

The guide surface 30G is substantially parallel to the XY plane. A third base plate 30 is supported by the support surface FL via vibration isolating apparatuses 31.

The substrate stage 2 and the measurement stage 3 are capable of moving by the operation of the drive systems 5, 6, respectively. In the present embodiment, the drive systems 5, 6 each comprise a planar motor. The planar motors for moving the substrate stage 2 and the measurement stage 3 comprise sliders 2M, 3M, which are respectively disposed in the substrate stage 2 and the measurement stage 3, and stators 30C, which are disposed in the third base plate 30, as disclosed in, for example, U.S. Pat. No. 6,452,292. In the present embodiment, the substrate stage 2 and the measurement stage 3 are each capable of moving in six directions—that is, in the X, Y, and Z axial directions and the θX, θY, and θZ directions—by the operation of the drive systems 5, 6, each of which comprises a planar motor.

The liquid immersion member 10 is disposed in the vicinity of the last optical element 27. The liquid immersion member 10 holds the liquid LQ between itself and an object, which is disposed in the projection region PR; furthermore, the liquid immersion member 10 is capable of forming the immersion space LS such that the optical path of the exposure light EL that emerges from the last optical element 27 is filled with the liquid LQ. The immersion space LS is a portion (i.e., a space or area) that is filled with the liquid LQ. In the present embodiment, the object that is capable of being disposed in the projection region PR includes at least one member selected from the group consisting of the substrate stage 2, the substrate P (or the dummy substrate DP) held by the substrate stage 2, the measurement stage 3, and the measuring members C (i.e., the measuring instruments) mounted on the measurement stage 3.

The liquid immersion member 10 has a lower surface 32 that is capable of opposing the object disposed in the projection region PR. Holding the liquid LQ between the emergent surface 28 and the lower surface 32 on one side and the front surface (i.e., the upper surface) of the object on the other side forms the immersion space LS such that the optical path of the exposure light EL between the last optical element 27 and the object is filled with the liquid LQ.

During the exposure of the substrate P, at least part of the front surface of the substrate P held by the substrate stage 2 opposes the lower surface 32 of the liquid immersion member 10. During the exposure of the substrate P, the liquid immersion member 10 forms the immersion space LS such that the optical path of the exposure light EL between the last optical element 27 and the substrate P is filled with the liquid LQ.

In the present embodiment, during the exposure of the substrate P, the immersion space LS is already formed such that part of the area of the front surface of the substrate P that includes the projection region PR is covered with the liquid LQ.

During the exposure of the substrate P, at least part of an interface LG (i.e., a meniscus or an edge) of the first liquid LQ is formed between the lower surface 32 of the liquid immersion member 10 and the front surface of the substrate P. Namely, the exposure apparatus EX of the present embodiment adopts a local liquid immersion system.

The transport apparatus 9 is capable of transporting the substrate P. The transport apparatus 9 is capable of performing at least one of these operations: an operation that loads the substrate P onto the substrate stage 2; and an operation that unloads the substrate P from the substrate stage 2.

In the present embodiment, the transport apparatus 9 performs a substrate exchanging process, which includes at least one of the following operations: an operation that loads the substrate P onto the substrate stage 2 before an exposure; and an operation that unloads the substrate P from the substrate stage 2 after an exposure. At least part of the transport apparatus 9 is capable of moving into the first space 12A through an opening 33.

A substrate exchange position CP is provided in the first space 12A. The substrate exchange position CP is a position at which at least one of the following operations can be performed: an operation that uses the transport apparatus 9 to load the substrate P onto the substrate stage 2 before an exposure; and an operation that uses the transport apparatus 9 to unload the substrate P from the substrate stage 2 after an exposure. The substrate exchange position CP is a position that differs from the position whereto the exposure light EL that emerges from the projection optical system PL can be radiated. The substrate stage 2 is capable of moving to the substrate exchange position CP.

The interferometer system 7 comprises: a first interferometer unit 7A, which is capable of optically measuring the position of the mask stage 1 (i.e., the mask M) within the XY plane; and a second interferometer unit 7B, which is capable of optically measuring the positions of the substrate stage 2 (i.e., the substrate P) and the measurement stage 3 (i.e., the measuring members C) within the XY plane.

The detection system 8 detects the position of the front surface of the substrate P held by the substrate stage 2. The detection system 8 according to the present embodiment is a so-called oblique incidence type multipoint focus and leveling detection system as disclosed in, for example, U.S. Pat. No. 5,448,332. In the present embodiment, the detection system 8 comprises first and second detection apparatuses 34, 35. At least part of the first detection apparatus 34 is disposed on the +Y side of the last optical element 27, and at least part of the second detection apparatus 35 is disposed on the −Y side of the last optical element 27. The first and second detection apparatuses 34, 35 respectively comprise projection apparatuses 34A, 35A, each of which radiates detection light to a detection point, and light receiving apparatuses 34B, 35B, each of which is capable of receiving the detection light from the front surface of the substrate P disposed at the detection point. In the present embodiment, the first and second detection apparatuses 34, 35 are supported by the first column 15 (i.e., the first base plate 20) via support mechanisms 36A, 36B, respectively.

Furthermore, the detection system 8 can detect not only the position of the front surface of the substrate P but also the positions of the front surfaces of the objects (e.g., an upper surface 2F of the substrate stage 2, an upper surface 3F of the measurement stage 3, and the like) that are capable of moving to a position at which they oppose the emergent surface 28 of the last optical element 27 or the lower surface 32 of the liquid immersion member 10, or both.

When an exposing process or a prescribed measuring process is performed on the substrate P, the control apparatus 11 controls the positions of the mask stage 1 (i.e., the mask M), the substrate stage 2 (i.e., the substrate P), and the measurement stage 3 (i.e., the measuring members C) by respectively operating the drive systems 4, 5, 6 based on the measurement results of the interferometer system 7 and the detection results of the detection system 8.

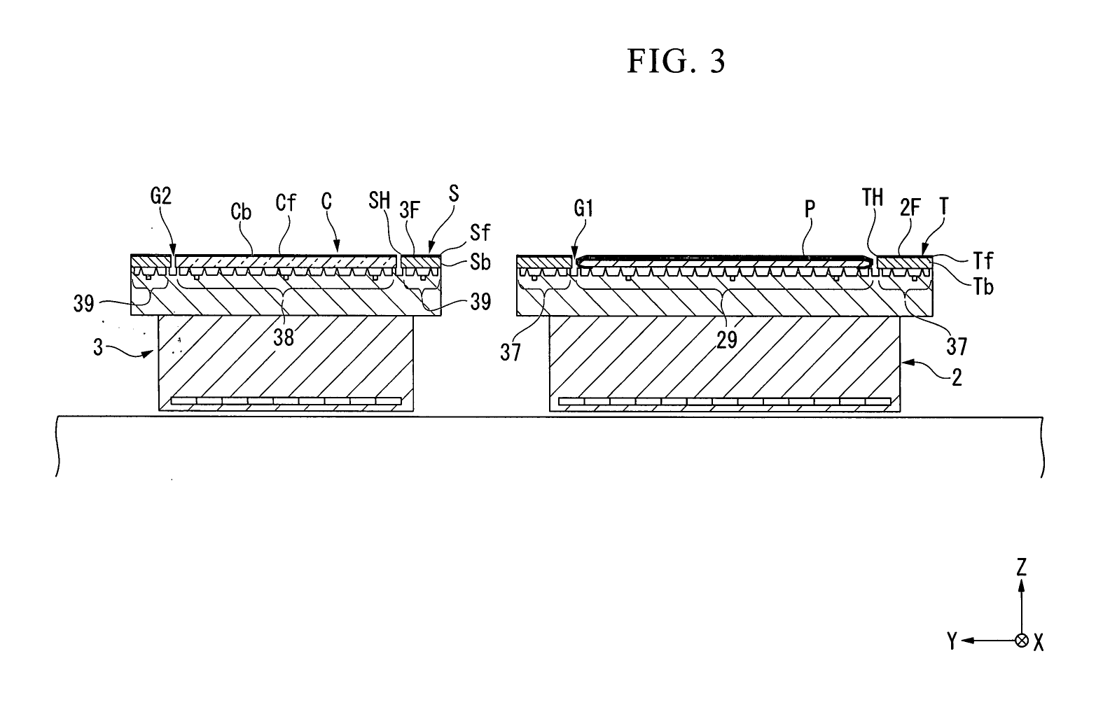

FIG. 3 is a side cross sectional view that shows one example of the substrate stage 2 and the measurement stage 3 according to the present embodiment. In the present embodiment, the substrate stage 2 comprises a first holding part 29, which comprises a pin chuck mechanism and releasably holds the substrate P, and a second holding part 37, which comprises a pin chuck mechanism and releasably holds a plate member T, as disclosed in U.S. Patent Application Publication No. 2007/0177125 and U.S. Patent Application Publication No. 2008/0049209.

The second holding part 37 is disposed around the first holding part 29. The plate member T has an opening TH in which the substrate P is capable of being disposed. The plate member T held by the second holding part 37 is disposed around the substrate P, which is held by the first holding part 29. In the present embodiment, the first holding part 29 is capable of holding the substrate P such that the front surface (i.e., the exposure surface) of the substrate P is substantially parallel to the XY plane. The second holding part 37 is capable of holding the plate member T such that the upper surface of the plate member T is substantially parallel to the XY plane. In the present embodiment, the front surface of the substrate P held by the first holding part 29 and the upper surface of the plate member T held by the second holding part 37 are disposed substantially within the same plane (i.e., they are substantially flush with one another). In addition, in the present embodiment, a side surface of the substrate P held by the first holding part 29 and a side surface (i.e., an inner side surface) of the plate member T held by the second holding part 37 oppose one another with a gap G1 interposed therebetween.

In the present embodiment, the upper surface 2F of the substrate stage 2 includes the upper surface of the plate member T held by the second holding part 37.

In the present embodiment, the plate member T comprises a metallic base material Tb, such as stainless steel, and a film Tf of a liquid repellent material, which is formed on the base material Tb. In the present embodiment, the upper surface of the plate member T, which contacts the liquid LQ in the immersion space LS, includes the front surface of the film Tf. Examples of liquid repellent materials include tetrafluoroethylene-perfluoroalkyl vinyl ether copolymer (PFA), polytetrafluoroethylene (PTFE), polyetheretherketone (PEEK), and Teflon®. Thereby, at least the upper surface of the plate member T is liquid repellent with respect to the liquid LQ. The contact angle of the liquid LQ with respect to the upper surface of the plate member T is, for example, 90° or greater. Alternatively, the plate member T can be configured not to be releasable. In the case, the second holding part 37 can be omitted.

In the present embodiment, the measurement stage 3 comprises third holding parts 38, which releasably hold the measuring members C, and a fourth holding part 39, which releasably holds a plate member S.

The fourth holding part 39 is disposed around the third holding parts 38. The plate member S has a plurality of openings SH in which the measuring members C are capable of being disposed. The plate member S held by the fourth holding part 39 is disposed around the measuring members C, which are held by the third holding parts 38. In the present embodiment, the third holding parts 38 are capable of holding the measuring members C such that the front surfaces of the measuring members C and the XY plane are substantially parallel. The fourth holding part 39 is capable of holding the plate member S such that the upper surface of the plate member S and the XY plane are substantially parallel. In the present embodiment, the front surfaces of the measuring members C held by the third holding parts 38 and the upper surface of the plate member S held by the fourth holding part 39 are disposed within substantially the same plane (i.e., they are substantially flush with one another). In addition, in the present embodiment, the side surfaces of the measuring members C held by the third holding parts 38 and the side surface (i.e., the inner side surface) of the plate member S held by the fourth holding part 39 oppose one another with gaps G2 interposed therebetween.

In the present embodiment, the upper surface 3F of the measurement stage 3 includes the front surfaces (i.e., the upper surfaces) of the measuring members C held by the third holding parts 38 and the upper surface of the plate member S held by the fourth holding part 39.

In the present embodiment, as in the plate member T, the plate member S comprises a base material Sb, which is made of stainless steel, and a PFA film Sf, which is formed on the base material Sb. In the present embodiment, the upper surface of the plate member S that contacts the liquid LQ in the immersion space LS includes the front surface of the film Sf.

In the present embodiment, each of the measuring members C comprises an optically transmissive base material Cb, which is made of, for example, quartz glass, and a film Cf, which is made of an optically transmissive liquid repellent material and is formed on the base material Cb. In the present embodiment, the upper surfaces of the measuring members C that contact the liquid LQ in the immersion space LS include the front surfaces of the films Cf. It is possible to use, for example, an amorphous fluororesin (i.e., hydrofluoroether) as the liquid repellent material. Thereby, at least the upper surfaces of the measuring members C are liquid repellent with respect to the liquid LQ. The contact angle of the liquid LQ with respect to the upper surface of each of the measuring members C is, for example, 90° or greater.

Alternatively, at least one of the measuring member C and the plate member S can be configured not to be releasable. In the case, at least one of the third holding part 38 and the fourth holding part 39 can be omitted.

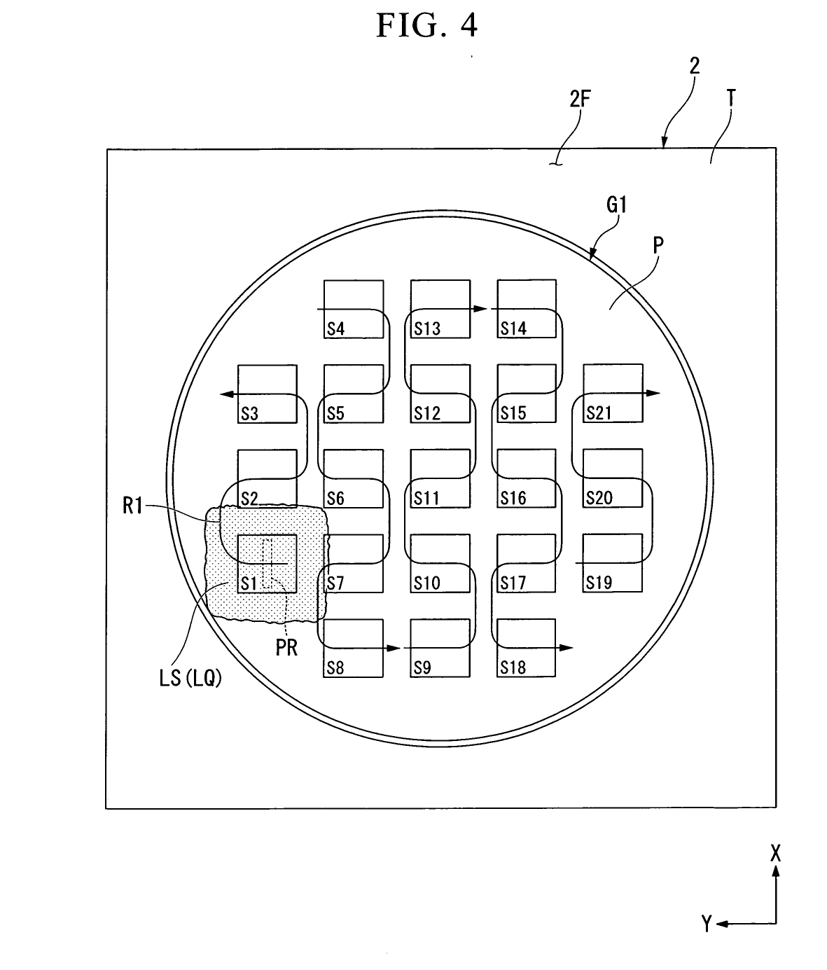

FIG. 4 is a plan view of the substrate P held by the substrate stage 2. As shown in FIG. 4, a plurality of shot regions S1-S21, each of which is an area to be exposed, is defined in a matrix on the substrate P. In addition, as shown in FIG. 4, in the present embodiment, the projection region PR is slit shaped such that its longitudinal directions are oriented in the X axial directions.

The exposure apparatus EX of the present embodiment is a scanning type exposure apparatus (i.e., a so-called scanning stepper) that projects the image of the pattern of the mask M to the substrate P while synchronously moving the mask M and the substrate P in prescribed scanning directions. During the exposure of the shot regions S1-S21 on the substrate P, the mask M and the substrate P are moved in the prescribed scanning directions within the XY plane. In the present embodiment, the scanning directions (i.e., the synchronous movement directions) of both the substrate P and the mask M are the Y axial directions. The control apparatus 11 radiates the exposure light EL to the substrate P through the projection optical system PL and the liquid LQ in the immersion space LS while both moving the shot regions S1-S21 on the substrate P in the Y axial directions with respect to the projection region PR and moving the patterned area of the mask M in the Y axial directions with respect to the illumination region IR synchronized to the movement of the substrate P in the Y axial directions. Thereby, the shot regions S1-S21 on the substrate P are exposed by the exposure light EL from the projection optical system PL (i.e., the last optical element 27) through the liquid LQ, and the image of the pattern of the mask M is projected to the shot regions S1-S21 on the substrate P.

When any one of the shot regions S1-S21 is to be exposed, the control apparatus 11 controls the substrate stage 2 so as to move the substrate P in the Y axial directions with respect to the projection region PR (i.e., the last optical element 27). In addition, after the exposure of a given shot region (e.g., the first shot region S1) ends, the control apparatus 11, in order to expose the next shot region (e.g., the second shot region S2) controls the substrate stage 2—in the state wherein the emergence of the exposure light EL from the last optical element 27 is stopped—so as to move the substrate P in prescribed directions within the XY plane with respect to the last optical element 27 such that the projection region PR is disposed at an exposure start position of the next shot region.

In the present embodiment, the control apparatus 11 successively exposes each of the shot regions S1-S21 on the substrate P by radiating the exposure light EL that emerges from the last optical element 27 to the projection region PR while moving the last optical element 27 and the substrate P (i.e., the substrate stage 2) relative to one another such that the projection region PR moves, for example, along an arrow R1 shown in FIG. 4.

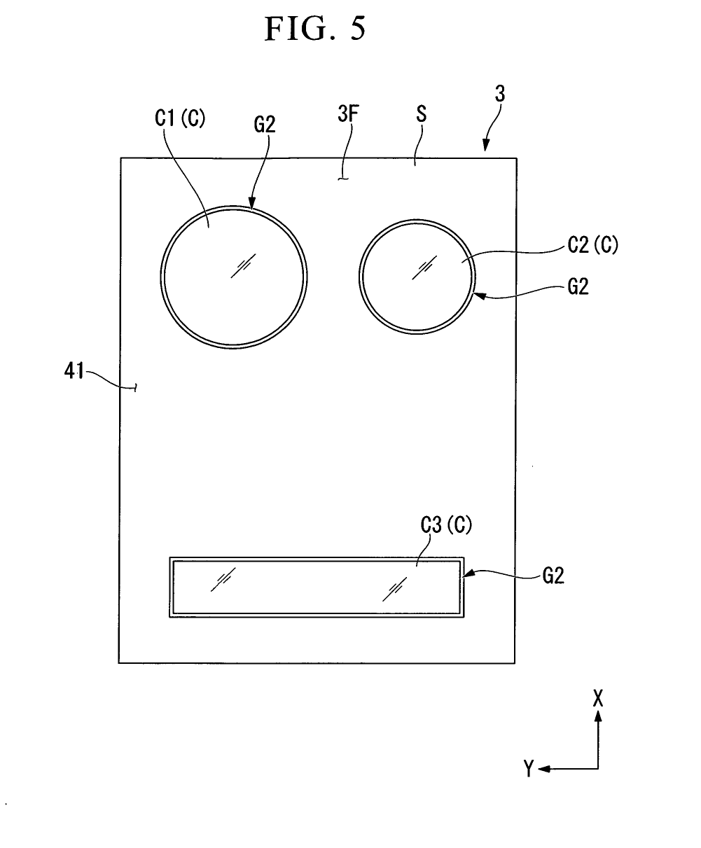

FIG. 5 is a plan view of the measurement stage 3 according to the present embodiment. The measurement stage 3 comprises the plurality of the measuring members C (i.e., the measuring instruments), which can perform exposure-related measurements. At least one of the measuring members C of the plurality of the measuring members C is capable of receiving the exposure light EL. The measuring members C comprises optical components. In the present embodiment, a slit plate C1, wherein an opening pattern (i.e., an optically transmissive part) is formed wherethrough the exposure light EL can transmit, is provided to the measurement stage 3 as one of the measuring members C. The slit plate C1 constitutes part of an aerial image measuring system, which is capable of measuring the aerial image formed by the projection optical system PL. The aerial image measuring system comprises the slit plate C1 and a light receiving device that receives the exposure light EL that emerges from the opening pattern of the slit plate C1. The control apparatus 11 radiates the exposure light EL to the slit plate C1 and, using the light receiving device to receive the exposure light EL that passes through the opening pattern of the slit plate C1, measures the image forming characteristics and the like of the projection optical system PL. In the present embodiment, the upper surface 3F of the measurement stage 3 includes the front surface of the slit plate C1. Furthermore, the aerial image measuring system is disclosed in, for example, U.S. Patent Application Publication No. 2002/0041377.

In addition, in the present embodiment, an upper plate C2, which serves as one of the measuring members C and wherein an opening pattern (i.e., an optically transmissive part) wherethrough the exposure light EL can transmit is formed, is disposed on the measurement stage 3. The upper plate C2 constitutes part of a luminous flux intensity nonuniformity measuring system, which is capable of measuring the nonuniformity of the luminous flux intensity of the exposure light EL. The luminous flux intensity nonuniformity measuring system comprises the upper plate C2 and a light receiving device, which receives the exposure light EL that emerges from the opening pattern of the upper plate C2. The control apparatus 11 measures the nonuniformity of the luminous flux intensity of the exposure light EL by radiating the exposure light EL to the upper plate C2 and using the light receiving device to receive the exposure light EL that passes through the opening pattern of the upper plate C2. In the present embodiment, the upper surface 3F of the measurement stage 3 includes the front surface of the upper plate C2. Furthermore, the luminous flux intensity nonuniformity measuring system is disclosed in, for example, U.S. Pat. No. 4,465,368.

In addition, a fiducial plate C3, which serves as one of the measuring members C, is disposed on the measurement stage 3. The fiducial plate C3 has a fiducial mark that is detected by an alignment system (not shown), which detects alignment marks on the substrate P. Furthermore, the fiducial plate C3 may be provided with a fiducial mark that is detected by detection light with a wavelength the same as that of the exposure light EL. The upper surface 3F of the measurement stage 3 includes the front surface of the fiducial plate C3. Furthermore, the fiducial plate C3 does not have to be provided to the measurement stage 3.

In the measurement stage 3 according to the present embodiment, the third holding parts 38 as explained referencing FIG. 3 are provided at a plurality of locations in order to hold the slit plate C1, the upper plate C2, and the fiducial plate C3. The third holding parts 38 releasably hold the slit plate C1, the upper plate C2, and the fiducial plate C3. Furthermore, the measuring members (i.e., the upper plates) mounted on the measurement stage 3 are not limited to the measuring members C1-C3 discussed above; for example, instead of at least some of the measuring members C1-C3 or in addition to the measuring members C1-C3, the measuring member of at least one measuring system that differs from the abovementioned measuring systems may be mounted on the measurement stage 3. Measuring systems other than the abovementioned measuring systems may include: a measuring system that can measure the amount of fluctuation in the transmittance of the exposure light EL of the projection optical system PL (e.g., as disclosed in U.S. Pat. No. 6,721,039); an irradiance measuring system, namely, a luminous flux intensity measuring system (e.g., as disclosed in U.S. Patent Application Publication No. 2002/0061469); a wavefront aberration measuring system (e.g., as disclosed in European Patent Application Publication No. 1079223); or the like.

One example of the exposure apparatus EX—which comprises the movable substrate stage 2 that holds the substrate P and the movable measurement stage 3 that does not hold the substrate P and is equipped with the measuring members C (i.e., the measuring instruments) that measure the exposure light EL—is disclosed in, for example, U.S. Pat. No. 6,897,963 and U.S. Patent Application Publication No. 2007/0127006.

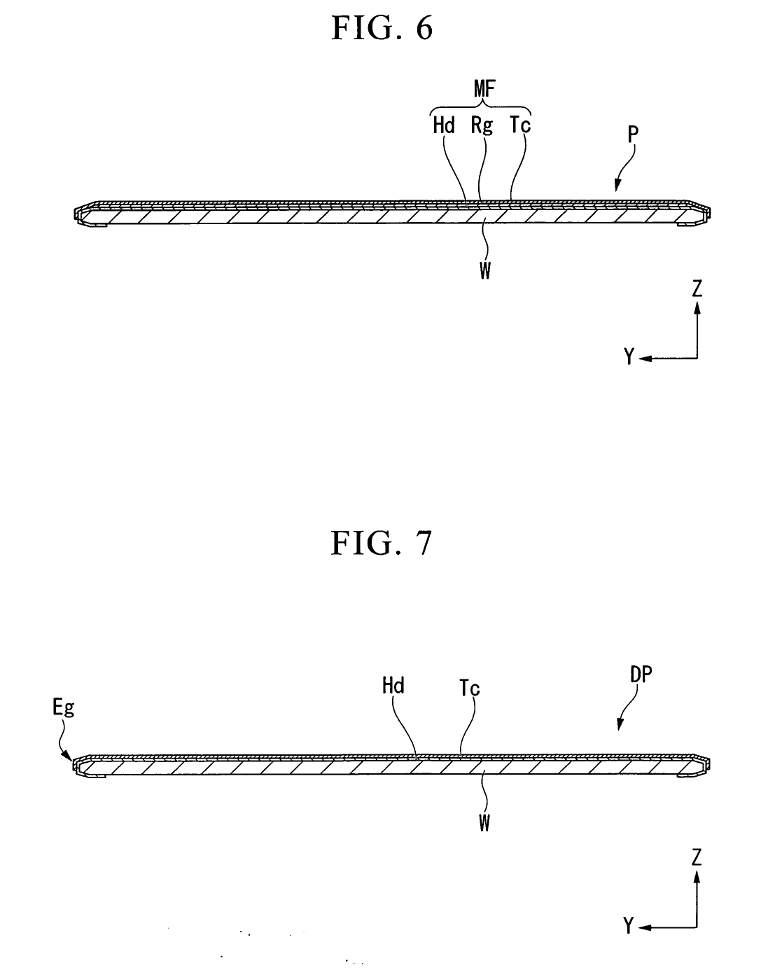

FIG. 6 is a side cross sectional view that shows one example of the substrate P according to the present embodiment. The substrate P is for fabricating devices. In the present embodiment, the substrate P comprises a base material W, such as a semiconductor wafer, and a multilayer film MF, which is formed on the base material W. In the present embodiment, the multilayer film MF comprises an HMDS film Hd, which is formed on the base material W, a photosensitive film Rg, which is formed on the HMDS film Hd, and a protective film Tc (i.e., a topcoat film), which protects the photosensitive film Rg. The HMDS film Hd is a film made of hexamethyldisilazane (HMDS). The photosensitive film Rg is made of a photosensitive material (e.g., photoresist). The protective film Tc is made of a material that includes, for example, fluorine, and is liquid repellent with respect to the liquid LQ. Furthermore, the contact angle of the liquid LQ with respect to the upper surface of the protective film Tc is, for example, 90° or greater. In the present embodiment, the front surface (i.e., the exposed surface) of the substrate P that contacts the liquid LQ includes the front surface of the protective film Tc.

Furthermore, the protective film Tc may be omitted. In addition, the front surface of the substrate P that contacts the liquid LQ may be the front surface of the photosensitive film Rg. In such a case, the front surface of the photosensitive film Rg would preferably be liquid repellent with respect to the liquid LQ. In this case, too, the contact angle of the liquid LQ with respect to the upper surface of the photosensitive film R9 would be, for example, 90° or greater. In addition, the substrate P may include films other than the photosensitive film Rg and the protective film Tc, for example, an antireflection film.

FIG. 7 is a side cross sectional view that shows one example of the dummy substrate DP according to the present embodiment. The dummy substrate DP is a substrate that is not used in the fabrication of a device. As discussed below, in the present embodiment, the dummy substrate DP is used in the operation of cleaning the members of the exposure apparatus EX. The dummy substrate DP has substantially the same external shape and size as the substrate P. The transport apparatus 9 is capable of transporting the dummy substrate DP. The first holding part 29 can releasably hold the dummy substrate DP.

In the present embodiment, the contact angle of the liquid LQ with respect to the front surface of the dummy substrate DP is substantially the same as that of the liquid LQ with respect to the front surface of the substrate P. As shown in FIG. 7, in the present embodiment, the dummy substrate DP comprises: the base material W, such as a semiconductor wafer; the HMDS film Hd, which is formed on the base material W; and the protective film Tc, which is formed on the HMDS film Hd. In the present embodiment, while the dummy substrate DP does not include the photosensitive film Rg, it may include such. In the present embodiment, as with the front surface (i.e., the exposed surface) of the substrate P, the front surface (i.e., the exposed surface) of the dummy substrate DP that contacts the liquid LQ includes the front surface of the protective film Tc. Furthermore, the base material W is not limited to a semiconductor wafer. In addition, in the present embodiment, the protective film Tc included on the substrate P is used to make the front surface of the dummy substrate DP liquid repellent with respect to the liquid LQ, but some other material may be used to make the front surface of the dummy substrate DP liquid repellent with respect to the liquid LQ. For example, instead of the protective film Tc and the HMDS film Hd, it is also possible to form on the base material W a monomolecular liquid repellent film that does not easily peel off. In addition, the base material W may be made of a material that is liquid repellent with respect to the liquid LQ. In such a case, a film made of a liquid repellent material would not have to be formed on the front surface of the base material W. In addition, neither the external shape nor the size necessarily has to be substantially the same as that of the substrate P.

In addition, in the present embodiment, the contact angle of the liquid LQ with respect to the front surface of the dummy substrate DP may be greater than the contact angle of the liquid LQ with respect to the front surface of the substrate P.

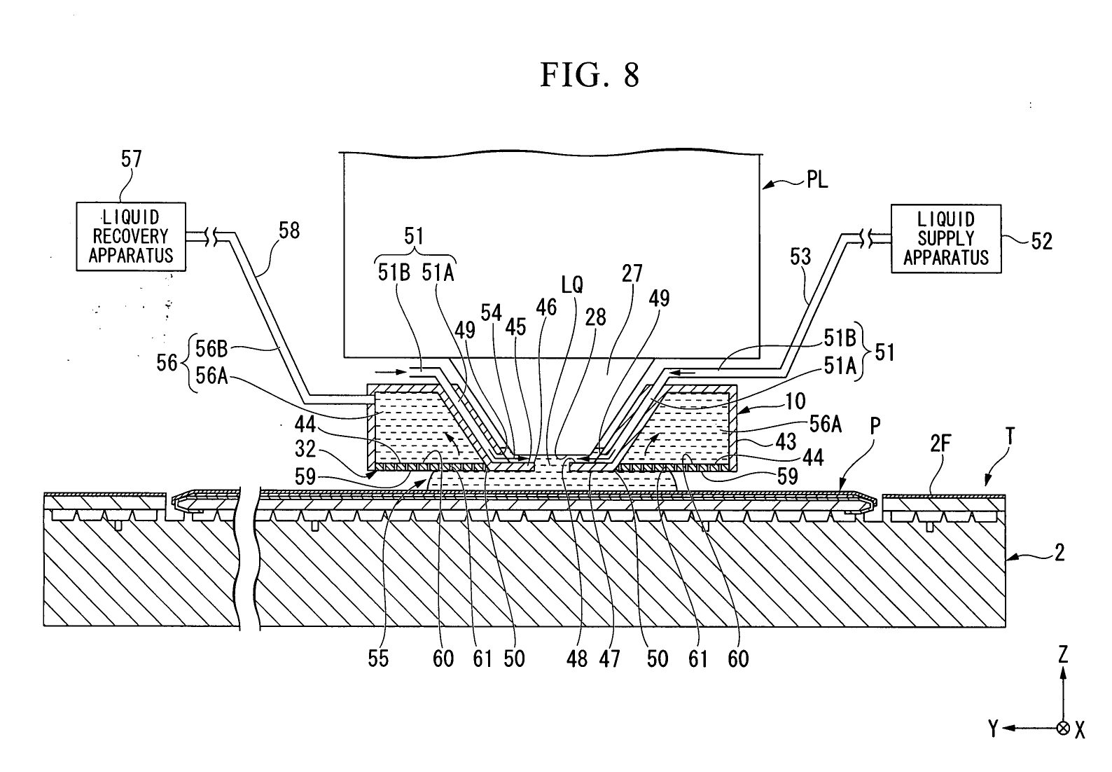

FIG. 8 is a side cross sectional view that shows one example of a liquid immersion member 10 according to the present embodiment. To simplify the explanation, the following text principally explains an exemplary state wherein the last optical element 27 and the liquid immersion member 10 on one side and the substrate P held by the substrate stage 2 on the other side oppose one another.

As shown in FIG. 8, in the present embodiment, the liquid immersion member 10 comprises a main body member 43 and a porous member 44. The porous member 44 is plate shaped and has a plurality of holes 61 (i.e., openings or pores). Alternatively, the liquid immersion member 10 can include no porous member 44.

The main body member 43 comprises a plate part 45, at least part of which is disposed between the emergent surface 28 of the last optical element 27 and the front surface of the substrate P in the Z axial directions. The plate part 45 has an opening 46 at its center. In addition, the plate part 45 has: a lower surface 47, which is disposed around the opening 46 and is capable of opposing the substrate P (i.e., the object) disposed at a position (i.e., the projection region PR) whereto the exposure light EL can be radiated; and an upper surface 48, which is on the side of the plate part 45 opposite that of the lower surface 47. At least part of the upper surface 48 opposes part of the emergent surface 28. The exposure light EL that emerges from the emergent surface 28 can pass through the opening 46.

In addition, the main body member 43 comprises supply ports 49, which are capable of supplying the liquid LQ onto the substrate P, and recovery port 50, which is capable of recovering the liquid LQ from the substrate P. The supply ports 49 are connected to a liquid supply apparatus 52 via supply passageways 51. The supply passageways 51 communicate with the supply ports 49. The liquid supply apparatus 52 is capable of supplying the liquid LQ, which is pure and temperature adjusted, to the supply ports 49 via the supply passageways 51. In the present embodiment, each of the supply passageways 51 comprises an internal passageway 51A, which is formed inside the main body member 43, and a passageway 51B, which is formed by a supply pipe 53 that connects the internal passageway 51A and the liquid supply apparatus 52. The supply ports 49 are disposed in the vicinity of the optical path of the exposure light EL at prescribed positions of the main body member 43 that face the optical path. In the present embodiment, the supply ports 49 supply the liquid LQ to a space 54 between the emergent surface 28 and the upper surface 48. The liquid LQ that is supplied from the supply ports 49 to the space 54 is supplied to a first space 55 between the lower surface 32 of the liquid immersion member 10 and the front surface of the substrate P via the opening 46.

The recovery port 50 is capable of recovering the liquid LQ from the first space 55 between the lower surface 32 of the liquid immersion member 10 and the front surface of the substrate P. The recovery port 50 is connected to a liquid recovery apparatus 57 via a recovery passageway 56. The liquid recovery apparatus 57 comprises a vacuum system (i.e., a vacuum source) and is capable of recovering the liquid LQ by suctioning it through the recovery passageway 56 and via the recovery port 50. In the present embodiment, the recovery passageway 56 comprises an internal passageway 56A, which is formed inside the liquid immersion member 10, and a passageway 56B, which is formed from a recovery pipe 58 that connects the recovery passageway 56A and the liquid recovery apparatus 57. The liquid recovery apparatus 57 recovers through the recovery passageway 56 the liquid LQ recovered via the recovery port 50.

In the present embodiment, the recovery port 50 is disposed around the optical path of the exposure light EL. The recovery port 50 is capable of recovering at least part of the liquid LQ on the substrate P opposing the lower surface 32 of the liquid immersion member 10.

The porous member 44 is disposed in the recovery port 50. In the present embodiment, the porous member 44 comprises: a lower surface 59, which is capable of opposing the substrate P disposed at a position whereto the exposure light EL can be radiated (i.e., the projection area PR); an upper surface 60, which is on the side of the porous member 44 opposite that of the lower surface 59; and the plurality of holes 61, which connects the lower surface 59 and the upper surface 60.

In the present embodiment, the lower surface 32 of the liquid immersion member 10 includes the lower surface 47 of the main body member 43 (i.e., the plate part 45) and the lower surface 59 of the porous member 44, which is disposed around the lower surface 47. The first space 55, which is capable of holding the liquid LQ, is formed between at least part of the lower surface 32 and the substrate P (i.e., the object).

Part of the first space 55 that is capable of holding the liquid LQ can be formed between the lower surface 59 of the porous member 44 and the substrate P.

The recovery passageway 56 comprises the internal passageway 56A, which faces the upper surface 60 of the porous member 44. In the explanation below, the internal passageway 56A is called the second space 56A where appropriate.

The lower end of each of the holes 61 faces the first space 55, and the upper end of each of the holes 61 faces the second space 56A. The first space 55 is connected to the second space 56A via the holes 61. The liquid LQ in the first space 55 is capable of moving to the second space 56A via the holes 61.

The liquid recovery apparatus 57 is capable of adjusting the pressure in the second space 56A. The liquid recovery apparatus 57 is capable of adjusting the pressure differential between the lower surface 59 and the upper surface 60 by adjusting the pressure in the second space 56A. In the present embodiment, the liquid recovery apparatus 57 suctions at least part of the liquid LQ in the first space 55 into the second space 56A via the porous member 44 by adjusting the pressure of the second space 56A, which includes the upper surface 60, such that it is lower than that of the first space 55.

In the present embodiment, to form the immersion space LS with the liquid LQ between the last optical element 27 and the liquid immersion member 10 on one side and the substrate P on the other side, the control apparatus 11 supplies the liquid LQ from the supply ports 49 to the first space 55 and, while doing so, adjusts the pressure in the second space 56A so as to recover the liquid LQ via the holes 61 (i.e., the recovery port 50) of the porous member 44. Performing both the liquid supply operation using the supply ports 49 and the liquid recovery operation using the recovery port 50 (i.e., the porous member 44) forms the immersion space LS with the liquid LQ between the last optical element 27 and the liquid immersion member 10 on one side and the substrate P on the other side. At least part of the liquid LQ in the immersion space LS is disposed in the first space 55.

Furthermore, it is also possible to use, as the liquid immersion member 10, a liquid immersion member (i.e., a nozzle member) as disclosed in, for example, U.S. Patent Application Publication No. 2007/0132976 and European Patent Application Publication No. 1768170.

In the present embodiment, the control apparatus 11 can synchronously move the substrate stage 2 and the measurement stage 3 in the X and Y directions with respect to the last optical element 27 and the liquid immersion member 10 while, at the same time, causing the emergent surface 28 of the last optical element 27 and the lower surface 32 of the liquid immersion member 10 on one side and either the upper surface 2F of the substrate stage 2 or the upper surface 3F of the measurement stage 3, or both, on the other side to oppose one another in the state wherein the upper surface 2F of the substrate stage 2 and the upper surface 3F of the measurement stage 3 are brought into proximity or contact with one another such that the substrate stage 2 or the measurement stage 3, or both, continuously forms a space that is capable of holding the liquid LQ between the last optical element 27 and the liquid immersion member 10, as disclosed in, for example, U.S. Pat. No. 7,372,538 and U.S. Patent Application Publication No. 2007/0127006. Thereby, the control apparatus 11 can switch between the state wherein the immersion space LS can be formed between the last optical element 27 and the liquid immersion member 10 on one side and the substrate stage 2 on the other side and the state wherein the immersion space LS can be formed between the last optical element 27 and the liquid immersion member 10 on one side and the measurement stage 3 on the other side. Namely, the control apparatus 11, while preventing the liquid LQ from leaking out, is capable of moving the immersion space LS of the liquid LQ between the upper surface 2F of the substrate stage 2 and the upper surface 3F of the measurement stage 3.

In the explanation below, the operation that—in the state wherein the upper surface 2F of the substrate stage 2 and the upper surface 3F of the measurement stage 3 are brought into proximity or contact with one another—synchronously moves the substrate stage 2 and the measurement stage 3 in the X and Y directions with respect to the last optical element 27 and the liquid immersion member 10 while causing the upper surface 2F of the substrate stage 2 or the upper surface 3F of the measurement stage 3, or both, on one side and the emergent surface 28 of the last optical element 27 and the lower surface 32 of the liquid immersion member 10 on the other side to oppose one another is called a “rugby scrum” movement where appropriate.

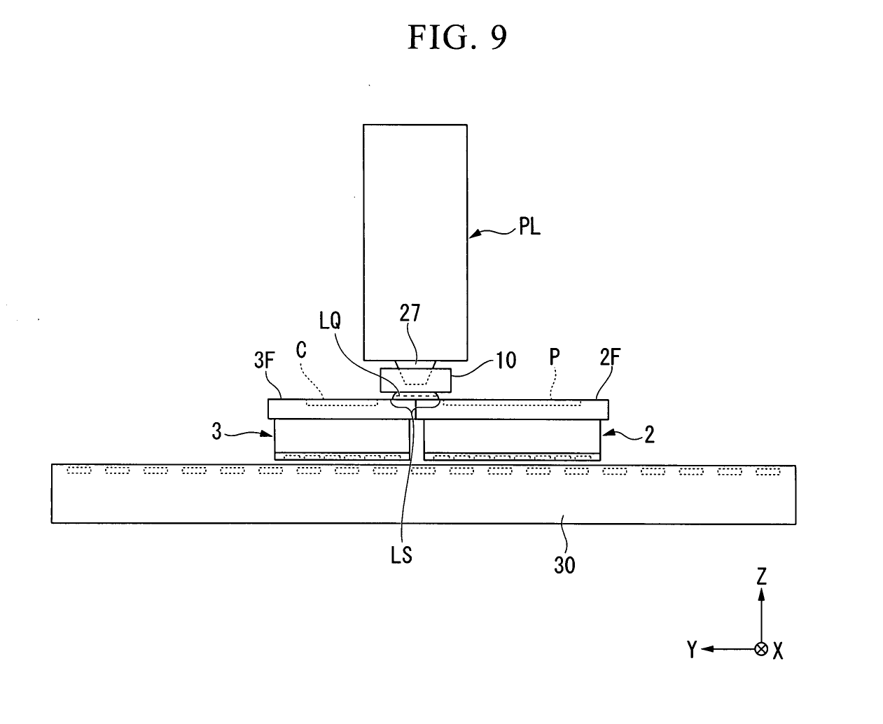

In the present embodiment, as shown in FIG. 9, when the “rugby scrum” movement is performed, the control apparatus 11 causes the +Y side side surface of the substrate stage 2 and the −Y side side surface of the measurement stage 3 to oppose one another. Furthermore, in the state wherein the +Y side linear edge of the substrate stage 2 and the −Y side linear edge of the measurement stage 3 are brought into contact or proximity with one another, the control apparatus 11 moves the substrate stage 2 and the measurement stage 3 simultaneously. In the present embodiment, when the “rugby scrum” movement is performed, the control apparatus 11 adjusts the posit ional relationship between the upper surface 2F of the substrate stage 2 and the upper surface 3F of the measurement stage 3 such that the upper surface 2F of the substrate stage 2 and the upper surface 3F of the measurement stage 3 are disposed within substantially the same plane.

In addition, when the measuring process is to be performed using the measuring member C1, the control apparatus 11 causes the last optical element 27 and the liquid immersion member 10 on one side and the upper surface 3F of the measurement stage 3 on the other side to oppose one another and forms the immersion space LS such that the optical path between the last optical element 27 and the measuring member C1 is filled with the liquid LQ. The control apparatus 11 performs the measuring process using the measuring member C1 by radiating the exposure light EL to the measuring member C1 through the projection optical system PL and the liquid LQ. The result of that measuring process is subsequently reflected in the exposing process to be performed on the substrate P.

In addition, when the exposing process of the substrate P is to be performed, the control apparatus 11 causes the last optical element 27 and the liquid immersion member 10 on one side and the substrate stage 2 on the other side to oppose one another and forms the immersion space LS such that the optical path of the exposure light EL between the last optical element 27 and the substrate P is filled with the liquid LQ. The control apparatus 11 radiates the exposure light EL, which emerges from the mask M illuminated with the exposure light EL from the illumination system IL, to the substrate P through the projection optical system PL and the liquid LQ. Thereby, the substrate P is exposed with the exposure light EL, and the image of the pattern of the mask M is projected onto the substrate P.

The following text explains one example of a method of using the exposure apparatus EX discussed above to expose the substrate P.

In the present embodiment, the exposure apparatus EX successively exposes the substrates P included in the lot with the exposure light EL through the liquid LQ. The lot is the process unit for the case wherein the substrates P are exposed under the same conditions. A single lot comprises, for example, 25 of the substrates P. In the present embodiment, a substrate housing apparatus 62 called a front opening unified pod (FOUP) is connected to the external apparatus CD. The substrate housing apparatus 62 houses one lot's worth (e.g., 25) of the substrates. The exposure apparatus EX and the external apparatus CD successively perform processes on the one lot's worth of the substrates housed in the substrate housing apparatus 62. For example, the external apparatus CD successively performs the process wherein the coating apparatus is used to form the multilayer film MF, which includes the HMDS film Hd, the photosensitive film Rg, the protective film Tc, and the like, on each of the substrates P (i.e., the base material W) included in one lot. Likewise, the exposure apparatus EX successively exposes the substrates P included in the one lot processed by the coating apparatus with the exposure light EL through the liquid LQ. Furthermore, the number of the substrates P in one lot is not limited to 25.

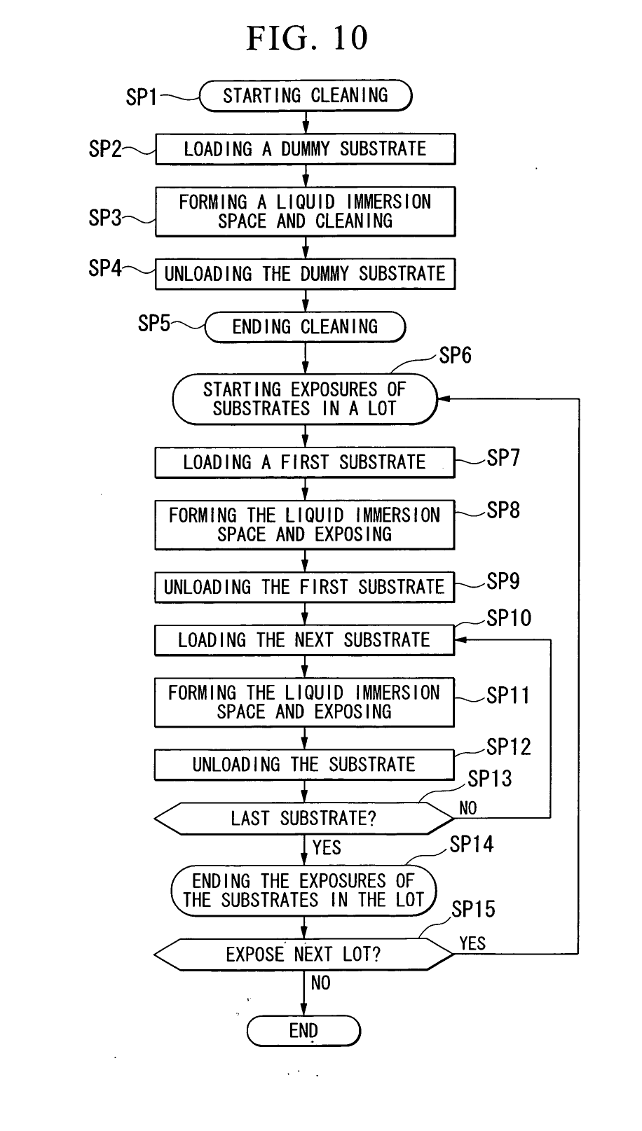

In the present embodiment, as shown in the flow chart in FIG. 10, the control apparatus 11 performs: a process (i.e., steps SP1-SP5) that, before the start of exposure of the first substrate P in the lot, forms the immersion space LS with the liquid LQ between the liquid immersion member 10 and the movable member, which is different than the first substrate P, such that the optical path of the exposure light EL is filled with the liquid LQ, and cleans the liquid immersion member 10 or the movable member, or both; and a process (i.e., steps SP6-SP14) that, after the cleaning, forms the immersion space LS with the liquid LQ between the liquid immersion member 10 and the first substrate P in the lot such that the optical path of the exposure light EL is filled with the liquid LQ, starts the exposure of the first substrate P, and successively exposes each of the substrates P in the lot that includes that first substrate P with the exposure light EL through the liquid LQ.

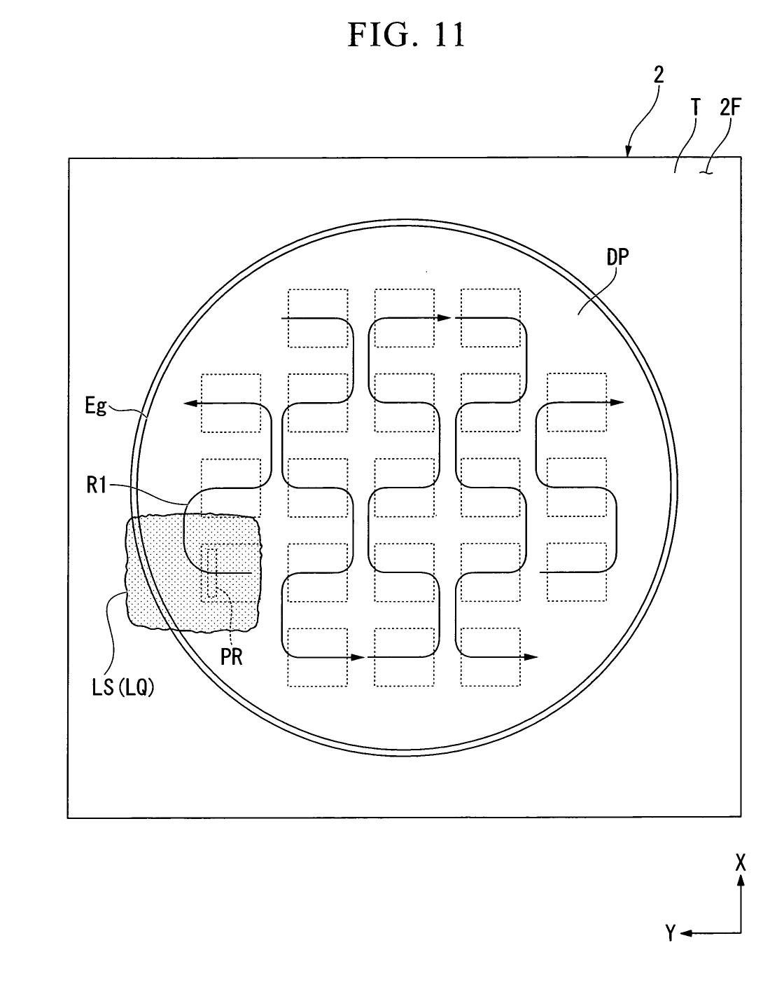

One example of the operation of the exposure apparatus EX according to the present embodiment will now be explained, referencing the flow chart in FIG. 10 and the schematic drawing in FIG. 11.

The external apparatus CD starts the process that is performed on the substrate P housed in the substrate housing apparatus 62. The external apparatus CD uses the coating apparatus to form the multilayer film MF on the substrate P. After the state is reached wherein the multilayer film MF is formed on the substrate P and that substrate P can be exposed, the external apparatus CD outputs a signal (i.e., a lot header signal) to the exposure apparatus EX (i.e., the control apparatus 11) to the effect that the first substrate P in the lot can be supplied to the exposure apparatus EX.

After receiving the lot header signal from the external apparatus CD and before the first substrate P in the lot is supplied therefrom, the control apparatus 11 starts the cleaning operation (i.e., the step SP1). Before the first substrate P in the lot is held by the substrate stage 2, the control apparatus 11 transports the dummy substrate DP from the transport apparatus 9 to the substrate stage 2 (i.e., the step SP2).

In the present embodiment, before the exposure of the first substrate P in the lot is started, substantially all of the liquid LQ is recovered from the first space 55, and the immersion space LS is not formed. Namely, in the present embodiment, the cleaning operation is performed after substantially all of the liquid LQ has been recovered from the immersion space LS and before the processing of the next lot has started. Namely, in the present embodiment, the control apparatus 11 starts the cleaning operation when the processing start instruction for the next lot is received in the state wherein the optical path on the image plane side of the projection optical system PL is filled with a gas. Furthermore, the state wherein the optical path on the image plane side of the projection optical system PL is filled with the gas might arise in cases such as, for example, when the exposure apparatus EX is not run for a long time or when the exposure apparatus EX undergoes maintenance.

As discussed above, the dummy substrate DP is disposed in the housing apparatus 17. The control apparatus 11 uses the transport apparatus 9 to load the dummy substrate DP disposed in the housing apparatus 17 onto the first holding part 29 of the substrate stage 2. The first holding part 29 holds the loaded dummy substrate DP.

Once the dummy substrate DP is held by the first holding part 29, the control apparatus 11 moves the substrate stage 2 to a position below the liquid immersion member 10 such that the lower surface 32 of the liquid immersion member 10 and the dummy substrate DP are opposed to one another. Next, the control apparatus 11 starts the operation of supplying the liquid LQ via the supply ports 49 and, in parallel with the performance of the operation of supplying the liquid LQ via the supply ports 49, performs the operation of recovering the liquid LQ via the recovery port 50, forms the immersion space LS with the liquid LQ between the liquid immersion member 10 and the front surface of the dummy substrate DP, and starts the cleaning of the liquid immersion member 10 (i.e., the step SP3).

In the present embodiment, in the state wherein the immersion space LS has been formed with the liquid LQ between the liquid immersion member 10 and the dummy substrate DP, the control apparatus 11 moves the substrate stage 2 in the X and Y directions and thereby moves the dummy substrate DP with respect to the liquid immersion member 10. Thereby, at least part of the lower surface 32 of the liquid immersion member 10 that contacts the liquid LQ or at least part of the emergent surface 28 of the last optical element 27, or both, are cleaned.

In the present embodiment, during the cleaning operation, the control apparatus 11 moves the substrate stage 2, which holds the dummy substrate DP, in the X and Y directions with respect to the liquid immersion member 10 such that the immersion space LS is formed on an edge Eg of the dummy substrate DP held by the substrate stage 2. By forming the immersion space LS on the edge Eg of the dummy substrate DP, at least part of the upper surface 2F of the substrate stage 2 (i.e., the upper surface of the plate member T) and the liquid LQ of the immersion space LS contact one another. Thereby, at least the substrate stage 2 is cleaned. In addition, at least part of the side surface of the plate member T that opposes the side surface of the dummy substrate DP can also be cleaned through its contact with the liquid LQ.

FIG. 11 shows one example of the locus of movement of the substrate stage 2, which holds the dummy substrate DP, during a cleaning. In the present embodiment, the locus of movement of the substrate stage 2 during cleaning is substantially the same as that of the substrate stage 2 during the exposure of the substrate P. Namely, in the present embodiment, as shown in FIG. 11, the substrate stage 2 is moved so as to expose hypothetical shot regions on the dummy substrate DP. In addition, in the present embodiment, the velocity and the acceleration of the substrate stage 2 during the cleaning are substantially the same as those of the substrate stage 2 during the exposure of the substrate P.

As was explained referencing FIG. 4, in the present embodiment, the locus of movement of the substrate stage 2 during the exposure of the substrate P is prescribed in advance. In the present embodiment, as shown in FIG. 11, during the cleaning the substrate stage 2 moves with respect to the liquid immersion member 10 such that the immersion space LS moves along the arrow R1. Moving the substrate stage 2 such that the immersion space LS moves along the arrow R1 forms the immersion space LS at least part of the edge Eg of the dummy substrate DP.

In the present embodiment, the contact angle of the liquid LQ with respect to the front surface of the dummy substrate DP is substantially the same as that of the liquid LQ with respect to the front surface of the substrate P. Accordingly, the immersion space LS is satisfactorily formed on the dummy substrate DP.

Making the locus of movement of the substrate stage 2 during the cleaning substantially the same as that of the substrate stage 2 during the exposure of the substrate P makes it possible for the liquid LQ during the cleaning to contact at least some area of the front surface of the member (i.e., the lower surface 32 of the liquid immersion member 10, and the like) that contacts the liquid LQ at least during the exposure of the substrate P, and thereby to satisfactorily clean that area.

For example, at least some area of the lower surface 32 of the liquid immersion member 10 can be cleaned. In addition, because the immersion space LS is formed on the edge Eg of the dummy substrate DP, at least part of the upper surface 2F of the substrate stage 2 or at least part of the side surface (i.e., the inner side surface) of the plate member T, or both, is cleaned by making contact with the liquid LQ of the immersion space LS. In addition, because the loci of movement of the substrate stage 2 during cleaning and during the exposure of the substrate P are substantially the same, some area of the upper surface 2F of the substrate stage 2 that contacts the liquid LQ at least during the exposure of the substrate P can also be brought into contact with the liquid LQ during cleaning, and consequently that area can be cleaned satisfactorily.

In the present embodiment, the control apparatus 11 causes the exposure light EL to emerge from the last optical element (a front optical element) 27 during at least part of the cleaning operation. In the present embodiment, the exposure light EL includes ultraviolet light. For example, in the state wherein the upper surface 2F of the substrate stage 2 and the liquid LQ of the immersion space LS are brought into contact with one another, radiating the exposure light EL to the upper surface 2F of the substrate stage 2 makes it possible to satisfactorily clean (i.e., photoclean) the upper surface 2F of the substrate stage 2. In addition, radiating the exposure light EL to the dummy substrate DP makes it possible to prevent the advance of any contamination of the dummy substrate DP. Furthermore, if there is a concern that the liquid repellency of the upper surface 2F of the substrate stage 2 or the front surface of the dummy substrate DP, or both, will decline, then the exposure light EL does not have to be emitted during cleaning, or the exposure light EL may be emitted such that it is radiated to only the dummy substrate DP or only the substrate stage 2.

Through the cleaning operation, at least part of the foreign matter (i.e., contaminant) eliminated from the liquid immersion member 10 or the substrate stage 2, or both, is recovered via the recovery port 50 together with the liquid LQ. In addition, at least part of the foreign matter (i.e., the contaminant) eliminated from the liquid immersion member 10 or the substrate stage 2, or both, adheres to the front surface of the dummy substrate DP.

After the cleaning is complete, the control apparatus 11 performs the “rugby scrum” movement and forms the immersion space LS between the liquid immersion member 10 and the measurement stage 3, after which it uses the transport apparatus 9 to unload the dummy substrate DP from the substrate stage 2 (i.e., the step SP4). The transport apparatus 9 unloads the foreign matter eliminated from the liquid immersion member 10 or the substrate stage 2, or both, from the substrate stage 2 together with the dummy substrate DP. The transport apparatus 9 transports the dummy substrate DP that was unloaded from the substrate stage 2 to the housing apparatus 17. The dummy substrate DP transported to the housing apparatus 17 is housed in the housing apparatus 17. Thereby, the cleaning of the liquid immersion member 10 and the substrate stage 2 ends (i.e., the step SP5).

Next, the control apparatus 11 starts the exposures of substrates P1-P25 in the lot (i.e., the step SP6).

The control apparatus 11 uses the transport apparatus 9 to load the first substrate P1 in the lot supplied from the external apparatus CD (i.e., the coating apparatus) onto the substrate stage 2 (i.e., the step SP7). Furthermore, the control apparatus 11 performs the “rugby scrum” movement, forms the immersion space LS between the liquid immersion member 10 and the substrate P1 held by the substrate stage 2, and starts the exposure of the first substrate P1 (i.e., the step SP8). While moving the substrate stage 2, which holds the substrate P1, with respect to the last optical element 27 and the liquid immersion member 10 such that the projection region PR moves along the arrow R1, the control apparatus 11 successively exposes the plurality of shot regions S1-S21 of the substrate P1, as was explained referencing FIG. 4.

After the exposure of the first substrate P1 is complete, the control apparatus 11 performs the “rugby scrum” movement, forms the immersion space LS between the liquid immersion member 10 and the measurement stage 3, and uses the transport apparatus 9 to unload the exposed first substrate P1 from the substrate stage 2 (i.e., the step SP9). In addition, the control apparatus 11 uses the transport apparatus 9 to load the substrate P2, which is to be exposed next, in the lot supplied from the external apparatus CD (i.e., the coating apparatus) onto the substrate stage 2 (i.e., the step SP10). The exposed first substrate P1 unloaded from the substrate stage 2 is supplied to the external apparatus CD, where it undergoes a prescribed process such as a developing process.

The control apparatus 11 forms the immersion space LS on the substrate P2 and starts the exposure of the substrate P2 (i.e., the step SP11). After the exposure of the substrate P2 is complete, the control apparatus 11 unloads the exposed substrate P2 (i.e., the step S12).

The control apparatus 11 determines whether the exposed substrate P2 is the last substrate P25 in the lot (i.e., the step SP13). If it is determined that it is not the last substrate P25 in the lot, then the control apparatus 11 loads the next substrate, that is, the substrate P3, onto the substrate stage 2 and exposes the substrate P3. Subsequently, the control apparatus 11 successively exposes each of the 25 substrates P1-P25 included in the lot through the liquid LQ by repetitively performing the processes discussed above until the exposure of the last substrate P25 in the lot is complete.

In step SP14, if it is determined that the exposed substrate P25 is the last one in the lot, then the control apparatus 11 determines that the exposures of the 25 substrates in that lot is complete (i.e., the step SP14).

The control apparatus 11 determines whether to expose the next lot (i.e., the step SP15). If it is determined that the next lot is to be exposed, then the control apparatus 11 performs the processes discussed above, returns to the step SP6, and starts the processing of the next lot.

In the step SP15, if it is determined that the next lot is not to be exposed, then the sequence of operations ends and the control apparatus 11 waits in the idling state for the next instruction; in the idling state, the control apparatus 11 moves the measurement stage 3 to a position below the last optical element 27 and the liquid immersion member 10 and maintains the immersion space LS between the last optical element 27 and the liquid immersion member 10 on one side and the measurement stage 3 on the other side. At this time, the measurement stage 3 may move while the immersion space LS is maintained.

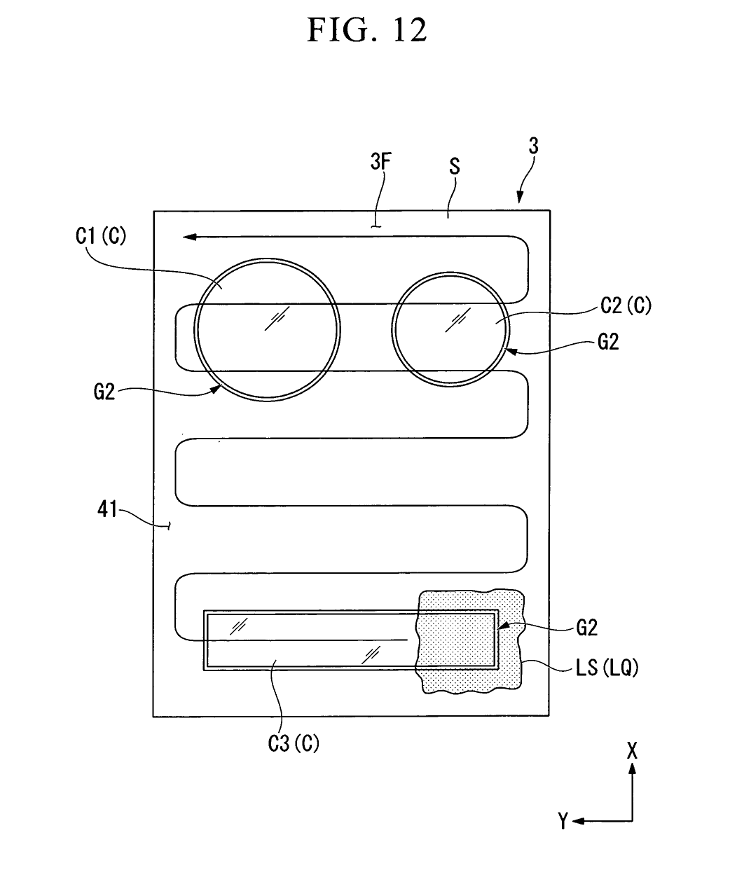

Furthermore, if the process of exposing the next lot starts from the idling state, then the cleaning operation discussed above (i.e., the steps SP1-SP5) may be performed before the start of the exposure of the first substrate in the next lot or may not be performed at all. In the idling state, because the immersion space LS is maintained by the supplying and recovering of the liquid LQ, the last optical element 27, the liquid immersion member 10, the measurement stage 3, and the like are cleaned by making contact with the liquid LQ. Particularly in the idling state, for example, as shown in FIG. 12, moving the measurement stage 3 with respect to the liquid immersion member 10 in the state wherein the immersion space LS has been formed makes it possible to effectively clean the last optical element 27, the liquid immersion member 10, the measurement stage 3, and the like. Accordingly, if the processing of the next lot is started from the idling state, the cleaning operation discussed above (i.e., the steps SP1-SP5) can be omitted. In the meantime, also in the idling state, at least a part of the last optical element 27, the liquid immersion member 10, and the measurement stage 3 might become contaminated; therefore, the above-described cleaning operation (SP1-SP5) can be performed before the start of the exposure of the first substrate in the nest lot. For example, the above-described cleaning operation (SP1-SP5) can be performed when a predetermined time has elapsed after the completion of process for the last lot. Alternatively, in the idling state, while holding the dummy substrate DP described above by the substrate stage 2, the liquid immersion space LS can be maintained between the last optical element 27 and the liquid immersion member 10 on one side and the dummy substrate DP on the other side. In this case, the substrate stage 2 can move while the liquid immersion space LS is maintained on the dummy substrate DP.

In addition, in the step SP15, if it is determined that the process of exposing the next lot is not to be started, then, without waiting for the next instruction in the idling state, the full recovery operation, wherein substantially all of the liquid LQ is recovered from the optical path of the exposure light EL, may be performed. Furthermore, if the process of exposing the next lot is to be started after the full recovery operation, then it is preferable to perform the cleaning operation (i.e., the steps SP1-SP5) before the first substrate of the next lot is exposed, as discussed above.

Incidentally, in the present embodiment, the calibration of the detection system 8 is performed in parallel with at least part of the cleaning described in the step SP3 discussed above.

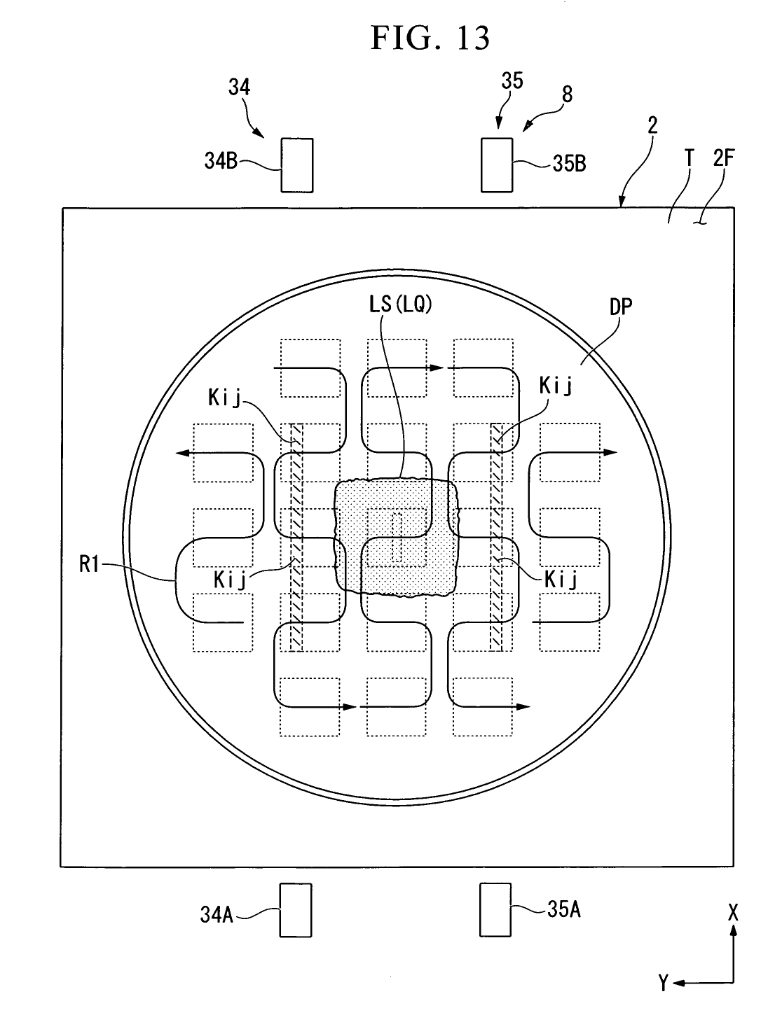

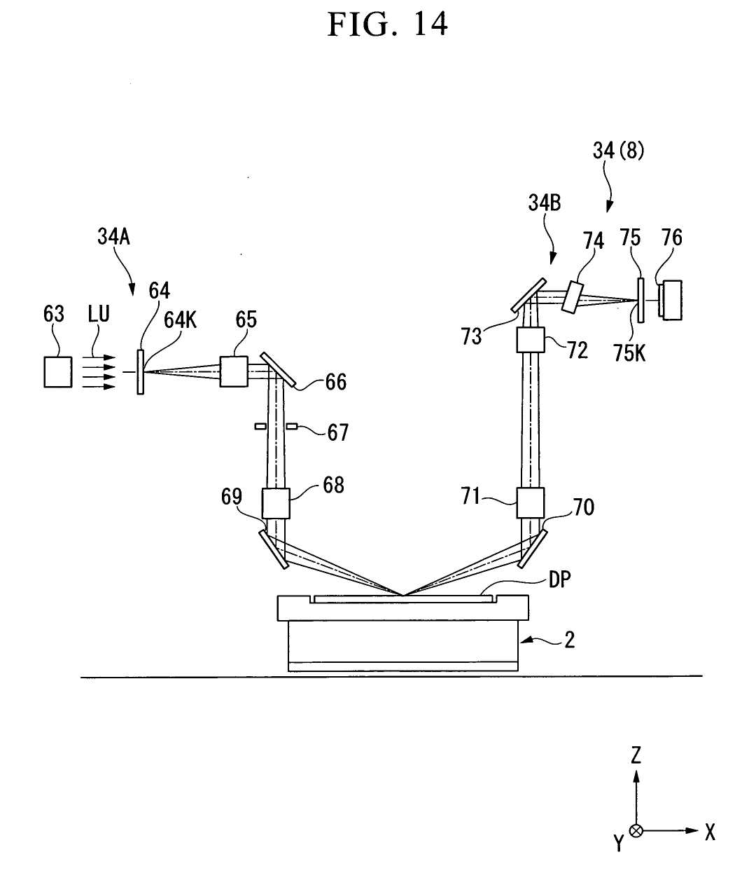

FIG. 13 and FIG. 14 are views that show one example of the detection system 8 according to the present embodiment. As discussed above, the detection system 8 comprises: the first detection apparatus 34, which is supported by the first base plate 20 via the support mechanism 36A; and the second detection apparatus 35, which is supported by the first base plate 20 via the support mechanism 36B. As shown in FIG. 13, the first and second detection apparatuses 34, 35 comprise the projection apparatuses 34A, 35A, which radiate detection lights LU to detection points Kij; and the light receiving apparatuses 34B, 35B, which are capable of receiving the detection lights LU from the front surface of the substrate P (i.e., the object) disposed at the detection points Kij. A plurality of the detection points Kij of the first detection apparatus 34 is disposed in the X axial directions on the +Y side of the immersion space LS. A plurality of the detection points Kij of the second detection apparatus 35 is disposed in the X axial directions on the −Y side of the immersion space LS. The first and second detection apparatuses 34, 35 can detect the position of the front surface of the substrate P in the Z axial directions at each of the detection points Kij. The control apparatus 11 can detect the position of the front surface of the substrate P in the Z axial, the θX, and the θY directions based on height position information Zij, which corresponds to the position of the front surface of the substrate P detected at each of the detection points Kij, output from the detection system 8.

FIG. 14 is a view that shows one example of the projection apparatus 34A and the light receiving apparatus 34B of the first detection apparatus 34. In FIG. 14, the projection apparatus 34A comprises: a light source 63, which emits the detection light LU; a slit plate 64, which has a slit shaped opening 64K that is illuminated by the detection light LU emitted from the light source 63; a lens system 65, into which the detection light LU that passes through the opening 64K of the slit plate 64 enters; a mirror 66, onto which the detection light LU that transits the lens system 65 impinges; a stop member 67, into which the detection light LU that transits the mirror 66 enters; an objective 68, into which the detection light LU that transits the stop member 67 enters; and a mirror 69, onto which the detection light LU that transits the objective 68 impinges. The detection light LU that transits the mirror 69 impinges the front surface of the substrate P from an inclined direction.

The light receiving apparatus 34B comprises: a mirror 70, onto which the detection light LU reflected by the front surface of the substrate P impinges; an objective 71, into which the detection light LU that transits the mirror 70 enters; a lens system 72, into which the detection light LU that transits the objective 71 enters; a vibrating mirror 73, onto which the detection light LU that transits the lens system 72 impinges; a plane parallel plate 74, into which the detection light LU that transits the vibrating mirror 73 enters; a slit plate 75, into which the detection light LU that transits the plane parallel plate 74 enters; and a photosensor 76, onto which the detection light LU that passes through a slit shaped opening 75K of the slit plate 75 impinges.

The height position information Zij detected by the photosensor 76 is output to the control apparatus 11. The control apparatus 11 uses the height position information Zij output from the photosensor 76 to ascertain the position of the front surface of the substrate P at a best image forming plane Zo.

The above text explained the projection apparatus 34A and the light receiving apparatus 34B of the first detection apparatus 34. The projection apparatus 35A and the light receiving apparatus 35B of the second detection apparatus 35 are configured identically to the projection apparatus 34A and the light receiving apparatus 34B of the first detection apparatus 34. The explanation of the projection apparatus 35A and the light receiving apparatus 35B of the second detection apparatus 35 is therefore omitted.

In the present embodiment, the adjustment (i.e., the calibration) of the detection system 8 is performed using the dummy substrate DP in parallel with at least part of the cleaning. In the present embodiment, the calibration of the detection system 8 includes: a first calibration operation, which performs an adjustment such that the output (i.e., the height position information Zij) of the first detection apparatus 34 and the output (i.e., the height position information Zij) of the second detection apparatus 35 coincide when the position of the front surface of the dummy substrate DP disposed at a prescribed position with respect to the best image forming plane Zo is detected; and a second calibration operation, which performs an adjustment such that the height position information Zij in the zero level state is output from each of the first and second detection apparatuses 34, when the first and second detection apparatuses 34, 35 detect the upper surface (i.e., the reference surface) of the slit plate C1 of the aerial image measuring system disposed in the best image forming plane Zo.

For example, if the front surface of the dummy substrate DP is disposed at the prescribed position with respect to the best image forming plane Zo, then a situation might arise wherein the height position information Zij output from the first detection apparatus 34 when it detects the position of the front surface of the dummy substrate DP and the height position information Zij output from the second detection apparatus 35 when it detects the position of the front surface of the dummy substrate DP differ from one another. For example, if the front surface of the dummy substrate DP and the best image forming plane Zo coincide, then the situation might arise wherein the height position information Zij in the zero level state is not output from the photosensor 76 of the second detection apparatus 35 whereas it is output from the photosensor 76 of the first detection apparatus 34.

In the present embodiment, if the front surface of the dummy substrate DP is disposed at the prescribed position with respect to the best image forming plane Zo, then the detection system 8 is calibrated in parallel with at least part of the cleaning such that the height position information Zij output from the first detection apparatus 34 when the position of the front surface of the dummy substrate DP is detected by the first detection apparatus 34 and the height position information Zij output from the second detection apparatus 35 when the position of the front surface of the dummy substrate DP is detected by the second detection apparatus 35 coincide.

In the present embodiment, in parallel with at least part of the cleaning, the control apparatus 11 uses the first and second detection apparatuses 34, 35 to detect the position of the front surface of the dummy substrate DP while both moving the substrate stage 2 along the locus of movement indicated by the arrow R1 and maintaining the state wherein the front surface of the dummy substrate DP is disposed at the prescribed position with respect to the best image forming plane Zo. Based on the result of that detection, the control apparatus 11 adjusts (i.e., calibrates) the state of the detection system 8 by, for example, moving the plane parallel plate 74 of at least one of the first and second detection apparatuses 34, 35 such that the height position information Zij the first detection apparatus 34 outputs when it detects the position of the front surface of the dummy substrate DP and the height position information Zij the second detection apparatus 35 outputs when it detects the position of the front surface of the dummy substrate DP coincide. Thereby, the first calibration operation, which causes the output (i.e., the height position information Zij) of the first detection apparatus 34 and the output (i.e., the height position information Zij) of the second detection apparatus 35 to coincide when the position of the front surface of the dummy substrate DP disposed at the prescribed position with respect to the best image forming plane Zo is detected, ends.

In the present embodiment, the second calibration operation, which performs an adjustment such that the height position information Zij in the zero level state is output by each of the first and second detection apparatuses 34, 35 when it detects that the upper surface (i.e., the reference surface) of the slit plate C1 of the aerial image measuring system coincides with the best image forming plane Zo, is performed after the first calibration operation.

To perform the second calibration operation, the control apparatus 11 radiates the exposure light EL to the slit plate C1 through the projection optical system PL while using the drive system 6 to move the measurement stage 3 in the Z axial directions in the state wherein the emergent surface 28 of the projection optical system PL and the upper surface (i.e., the reference surface) of the slit plate C1 on the measurement stage 3 are opposed to one another. The exposure light EL radiated to the slit plate C1 transits the opening pattern thereof and impinges the light receiving device of the aerial image measuring system. When the image plane Zo (i.e., the best image forming plane) of the projection optical system PL and the reference surface of the slit plate C1 coincide, the contrast of the exposure light EL received by the light receiving device of the aerial image measuring system is maximal. In other words, the position of the reference surface in the Z axial directions, whereat the contrast of the light received by the light receiving device is maximal, is the image plane Zo (i.e., the best image forming plane) of the projection optical system PL. Thus, the control apparatus 11 can use the aerial image measuring system to detect the position of the image plane Zo (i.e., the best image forming plane) of the projection optical system PL. Furthermore, the control apparatus 11 uses the first and second detection apparatuses 34, 35 of the detection system 8 to detect the position of the reference surface of the slit plate C1 disposed in the best image forming plane Zo and moves, for example, the plane parallel plate 74 such that the height position information Zij output from the light receiving device when that reference surface is detected transitions to a prescribed state (i.e., the zero level state). Thereby, when the detection system 8 detects the front surface of the substrate P disposed in the image plane Zo (i.e., the best image forming plane) of the projection optical system PL, the height position information Zij in the prescribed state (i.e., the zero level state) can be output from the photosensors 76 of the first and second detection apparatuses 34, 35.

As explained above, according to the present embodiment, before the start of the exposure of the first substrate P in the lot, the immersion space LS is formed with the liquid LQ between the liquid immersion member 10 and the dummy substrate DP, and at least part of the liquid immersion member 10 is cleaned using that liquid LQ; therefore, it is possible to start the exposure of the substrate P included in the lot using the liquid immersion member 10 in a clean state. In addition, in the present embodiment, during cleaning, it is possible to clean not only the liquid immersion member 10 but also at least part of the last optical element 27 or at least part of the substrate stage 2 (i.e., the plate member T), or both. Accordingly, it is possible to prevent exposure failures from occurring and defective devices from being produced.

If the porous member 10 and the like are left in a state wherein foreign matter (i.e., a contaminant) is adhered thereto, then that foreign matter might likewise adhere to the substrate P during an exposure or contaminate the liquid LQ supplied via the supply ports 49. As a result, exposure failures such as, for example, the generation of defects in the pattern formed on the substrate P might occur.

In the present embodiment, performing the cleaning operation before starting the exposure of the first substrate P (P1) in the lot cleans the liquid immersion member 10 and the like, which makes it possible to effectively prevent exposure failures from occurring and defective devices from being produced.

In addition, if substantially all of the liquid LQ in the immersion space LS is recovered before the start of the exposure of the first substrate P (P1) in the lot, then, for example, foreign matter suspended in midair might adhere to the liquid immersion member 10. In addition, the foreign matter might also adhere to the liquid immersion member 10 and the like before substantially all of the liquid LQ in the immersion space LS is recovered. If the immersion space LS is re-formed after substantially all of the liquid LQ in the immersion space LS is recovered, then foreign matter (e.g., substances such as fragments of the photosensitive material or fragments of the protective film, or both, produced by the substrate P) that adhere to the liquid immersion member 10 might tend to intermix with the liquid LQ in the immersion space LS. In such a case, there is a strong possibility that, after re-forming the immersion space LS, exposure failures will occur in the substrate P (P1), which was exposed first.

In the present embodiment, if the processing of the lot is started in the state wherein the immersion space LS is not formed, then cleaning is performed before the start of the exposure of the first substrate P (P1) in the lot, which makes it possible to start the exposure of the substrate P (P1) included in the lot using the liquid immersion member 10 and the like in the clean state.

In addition, in the present embodiment, during cleaning, the dummy substrate DP is used. Compared with the substrate P, the dummy substrate DP tends not to discharge foreign matter. Accordingly, using the dummy substrate DP makes it possible to satisfactorily clean the liquid immersion member 10 and the like.

In addition, because the dummy substrate DP can be replaced easily, the dummy substrate DP should be replaced with a new one if, for example, it becomes contaminated or the state of its front surface deteriorates. Furthermore, after usage, the dummy substrate DP can be reused for cleaning even without replacing it with a new one.

In addition, in the present embodiment, the detection system 8 is calibrated in parallel with at least part of the cleaning, which makes it possible to perform both the cleaning and the calibration efficiently while preventing a drop in throughput. Furthermore, the detection system 8 does not have to be calibrated in parallel with at least part of the cleaning.

In the present embodiment, the cleaning is performed after the external apparatus CD outputs a lot header signal to the exposure apparatus EX. Alternatively, the cleaning can be performed in parallel with at least a part of the preparation period of the external apparatus CD for supplying a first substrate P of a lot.

### Second Embodiment

The following text explains a second embodiment. In the explanation below, constituent parts that are identical or equivalent to those in the embodiment discussed above are assigned identical symbols, and the explanations thereof are therefore abbreviated or omitted.

The second embodiment differs from the first embodiment in that, if the processing of the next lot is not started after the processing of the current lot has been completed, the cleaning operation is performed.

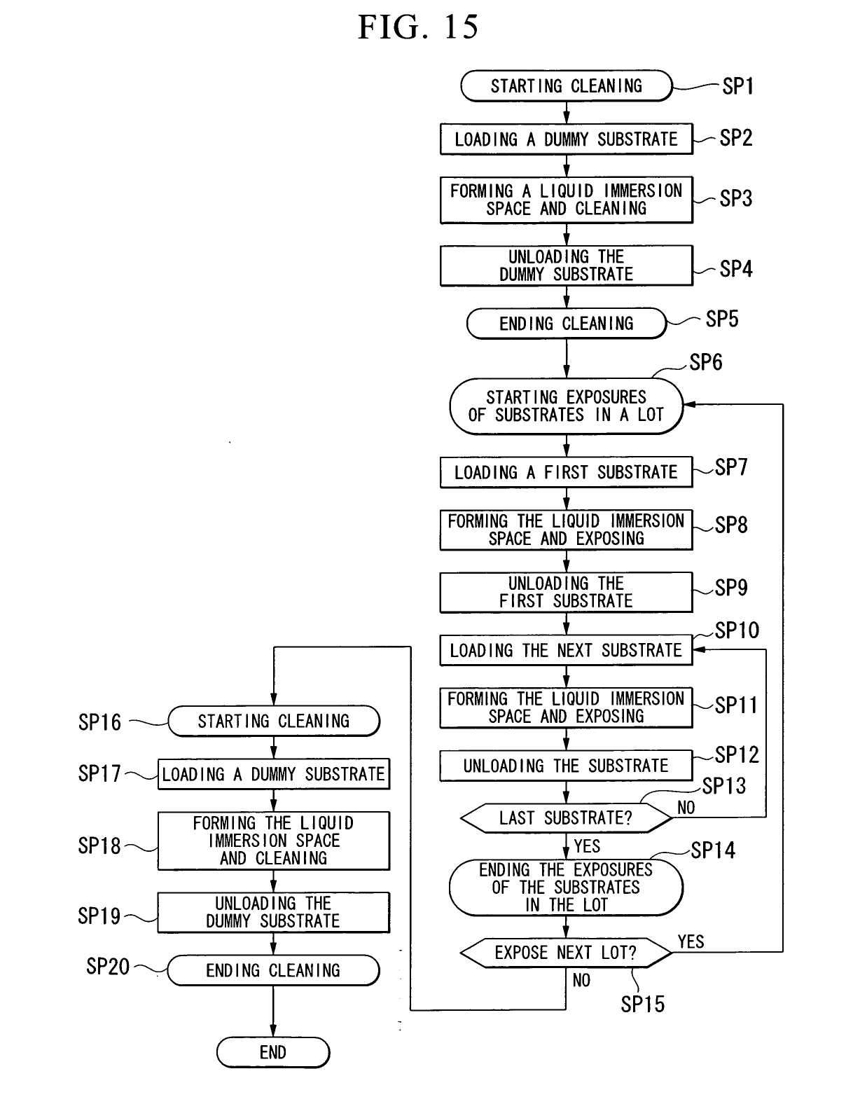

FIG. 15 is a flow chart that shows one example of the operation of the exposure apparatus EX according to the second embodiment. In FIG. 15, step SP1 through step SP15 are the same as in the first embodiment, and therefore a detailed explanation thereof is omitted. In the present embodiment, if processing of the next lot is not performed after the end of the exposure of the last substrate (P25) in the current lot, then the control apparatus 11 performs a process (i.e., the steps SP16-SP20) wherein the immersion space LS between the liquid immersion member 10 and the movable member, which differs from the last substrate (P25), is formed and the liquid immersion member 10 or the movable member, or both, is cleaned.

As explained in the first embodiment, after the end of the exposure of the last substrate (P25) in the lot, the control apparatus 11 determines whether to perform the process of exposing the next lot (i.e., the step SP15). If it is determined that the next lot is not to be processed, then the control apparatus 11 performs the cleaning operation (i.e., the steps SP16-SP20) as in the steps SP1-SP5 discussed above and cleans the liquid immersion member 10 or the substrate stage 2, or both. Namely, if it is determined that the next lot is not to be processed, then the control apparatus 11 starts the cleaning operation after the substrate P25 is unloaded from the substrate stage 2 (i.e., the step SP16).

The control apparatus 11 uses the transport apparatus 9 to transport the dummy substrate DP to the substrate stage 2 after the substrate P25 has been unloaded from the substrate stage 2 (i.e., the step SP17).

Once the dummy substrate DP is held by the first holding part 29 of the substrate stage 2, the control apparatus 11, as in the cleaning operation of the first embodiment, forms the immersion space LS with the liquid LQ between the liquid immersion member 10 and the front surface of the dummy substrate DP and cleans the liquid immersion member 10 and the like (i.e., the step SP18).

In the present embodiment, in the state wherein the immersion space LS is formed with the liquid LQ between the liquid immersion member 10 and the dummy substrate DP, the control apparatus 11 moves the substrate stage 2 in the X and Y directions, and thereby moves the dummy substrate DP with respect to the liquid immersion member 10. Thereby, as in the cleaning operation of the first embodiment, at least part of the lower surface 32 of the liquid immersion member 10, at least part of the emergent surface 28 of the last optical element 27, at least part of the upper surface 2F of the substrate stage 2 (i.e., the upper surface of the plate member T), or at least part of the side surface of the plate member T, or any combination thereof, is cleaned by making contact with the liquid LQ.

After the cleaning operation ends, the control apparatus 11 performs the “rugby scrum” movement, forms the immersion space LS between the liquid immersion member 10 and the measurement stage 3, and then uses the transport apparatus 9 to unload the dummy substrate DP from the substrate stage 2. The transport apparatus 9 transports the dummy substrate DP unloaded from the substrate stage 2 to the housing apparatus 17. The dummy substrate DP transported to the housing apparatus 17 is housed in the housing apparatus 17. Thereby, the cleaning ends (i.e., the step SP20). After the sequence of operations ends, the control apparatus 11 waits for the next instruction in the idling state, as in the first embodiment. In the idling state, the control apparatus 11 moves the measurement stage 3 to a position below the last optical element 27 and the liquid immersion member 10 and maintains the immersion space LS between the last optical element 27 and the liquid immersion member 10 on one side and the measurement stage 3 on the other side. As explained in the first embodiment, the measurement stage 3 may be moved in the idling state. In the idling state, as in the first embodiment, while the substrate stage 2 holds a dummy substrate, which is different from the dummy substrate DP used for the cleaning performed after the process for a lot, the liquid immersion space LS can be maintained between the dummy substrate on one side and the last optical element 27 and the liquid immersion member 10 on the other side.

In addition, in the present embodiment, if the processing of the next lot is started from the idling state, then the cleaning operation (i.e., the steps SP1-SP5) before the exposure of the first substrate of the next lot may be omitted.

Furthermore, after the cleaning operation in the steps SP16-SP20 ends, the full recovery operation, wherein substantially all of the liquid LQ is recovered from the optical path of the exposure light EL, may be performed. In such a case, because the cleaning operation is performed before the full recovery operation is performed, the amount of foreign matter (i.e., contaminant) discharged from the liquid immersion member 10 and the like can be reduced even if the immersion space LS is re-formed in order to start the process of exposing the next lot. Accordingly, the cleaning operation before the exposure of the first substrate of the next lot (i.e., the steps SP1-SP5) may either be omitted or not omitted. For example, the cleaning operation (i.e., the steps SP1-SP5) before the exposure of the first substrate of the next lot may be performed based on whether when the time elapsed since the full recovery operation exceeds a prescribed time.

In addition, in the present embodiment, during at least part of the cleaning operation (i.e., the steps SP16-SP20), the exposure light EL may or may not be emitted from the last optical element 27.

### Third Embodiment

The following text explains a third embodiment. In the explanation below, constituent parts that are identical or equivalent to those in the embodiments discussed above are assigned identical symbols, and the explanations thereof are therefore abbreviated or omitted.

The first and second embodiments discussed above explained cases wherein the locus of movement of the substrate stage 2 during cleaning is substantially the same as that of the substrate stage 2 during the exposure of the substrate P. The third embodiment differs from the first and second embodiments in that the locus of movement of the substrate stage 2 during cleaning differs from that of the substrate stage 2 during the exposure of the substrate P. Namely, it is possible to use, during the cleaning operation (i.e., the steps SP1-SP5) of the first embodiment discussed above, the locus of movement of the substrate stage 2 of the third embodiment. Alternatively, the locus of movement of the substrate stage 2 of the third embodiment may be used during the cleaning operation before the processing of the lot in the second embodiment discussed above (i.e., the steps SP1-SP5) or during the cleaning operation after the processing of the lot (i.e., the steps SP16-SP20), or both.

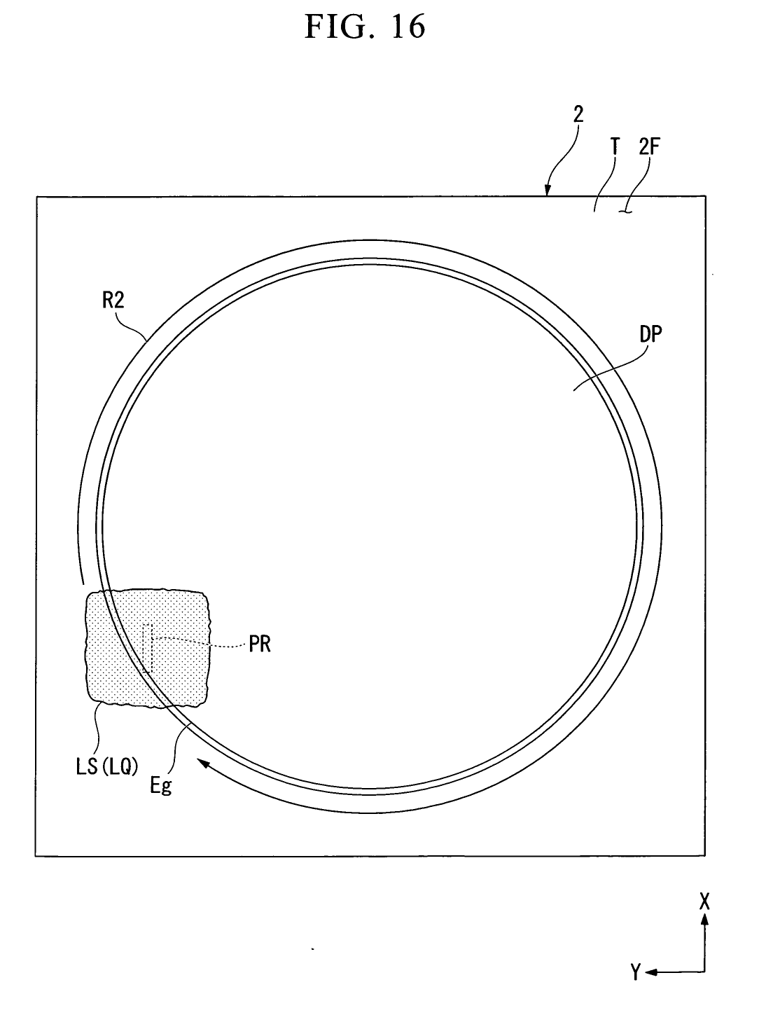

FIG. 16 and FIG. 17 show one example of the locus of movement of the substrate stage 2 during cleaning according to the third embodiment. During cleaning, the control apparatus 11 can move the substrate stage 2 with respect to the liquid immersion member 10 such that the immersion space LS of the liquid LQ moves along the edge Eg of the dummy substrate DP held by the substrate stage 2. For example, as shown in FIG. 16, during cleaning, the control apparatus 11 can move the dummy substrate DP (i.e., the substrate stage 2) with respect to the liquid immersion member 10 (i.e., the immersion space LS) such that the immersion space LS moves along an arrow R2. Thereby, at least part of the liquid immersion member 10 or the upper surface 2F of the substrate stage 2 (i.e., the plate member T) in the vicinity of the edge Eg, or both, is cleaned by the liquid LQ in the immersion space LS. In addition, at least part of the side surface of the substrate stage 2 (i.e., the plate member T) that opposes the side surface of the dummy substrate DP is also cleaned by the liquid LQ.

In addition, during cleaning, the control apparatus 11 can move the substrate stage 2 with respect to the liquid immersion member 10 such that the immersion space LS transitions between the state wherein it is formed on the dummy substrate DP held by the substrate stage 2 and the state wherein it is formed on the upper surface 2F of the substrate stage 2. For example, as shown in FIG. 17, during cleaning, the control apparatus 11 moves the dummy substrate DP (i.e., the substrate stage 2) with respect to the liquid immersion member 10 (i.e., the immersion space LS) such that the immersion space LS moves along an arrow R3. Thereby, at least part of the liquid immersion member 10 or at least part of the substrate stage 2, or both, is cleaned by the liquid LQ in the immersion space LS.

### Fourth Embodiment

The following text explains a fourth embodiment. In the explanation below, constituent parts that are identical or equivalent to those in the embodiments discussed above are assigned identical symbols, and the explanations thereof are therefore abbreviated or omitted.

The first through third embodiments discussed above explained cases wherein, during at least part of the cleaning, the substrate stage 2 is moved such that the immersion space LS is formed on the edge Eg of the dummy substrate DP held by the substrate stage 2. The fourth embodiment differs from the first through third embodiments in that, during cleaning, the substrate stage 2 is moved with respect to the liquid immersion member 10 such that the immersion space LS is not formed on the edge Eg of the dummy substrate DP held by the substrate stage 2.

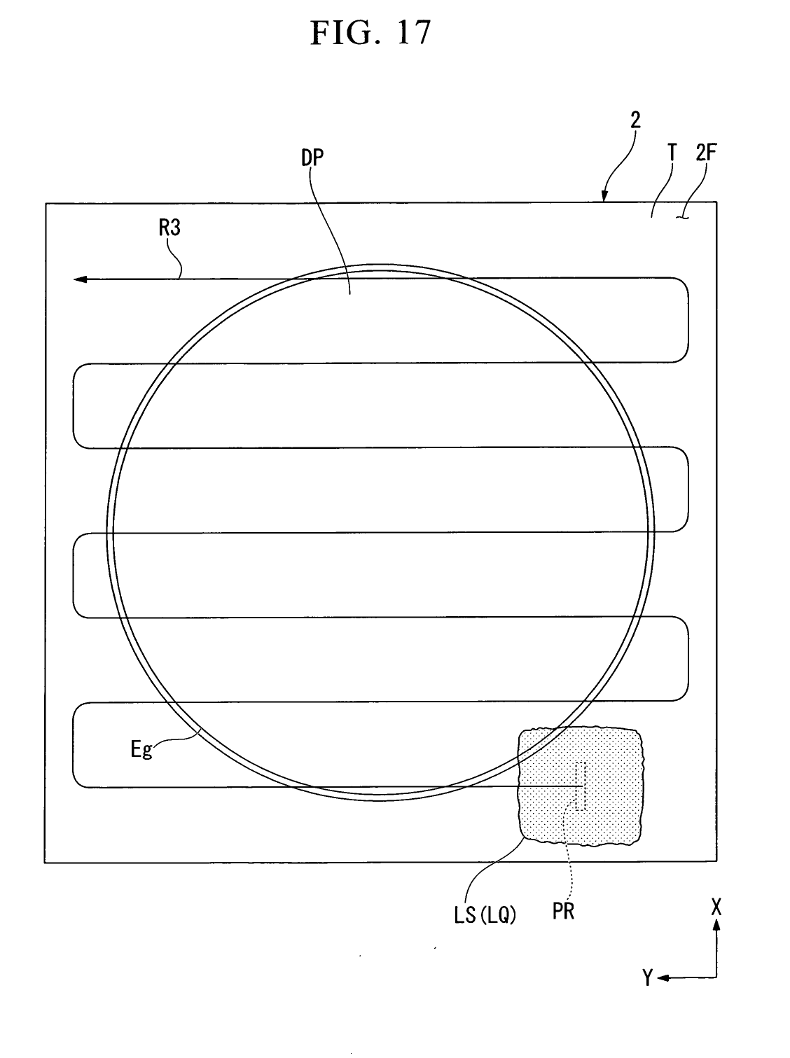

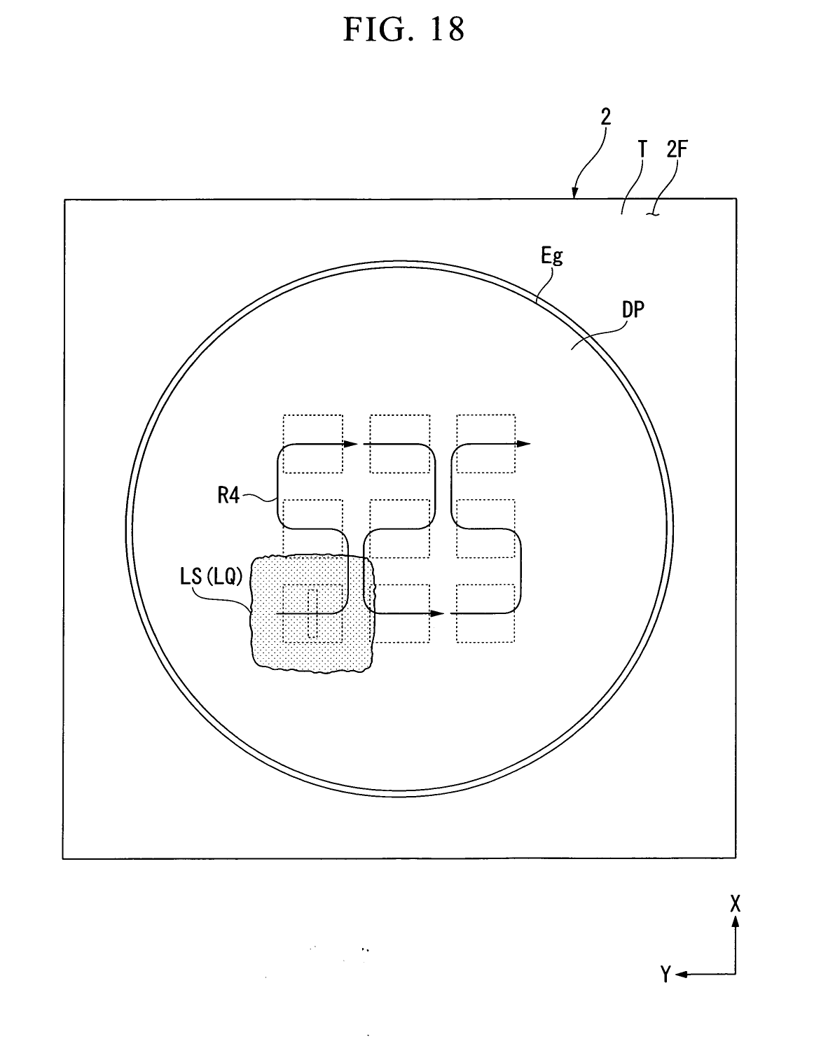

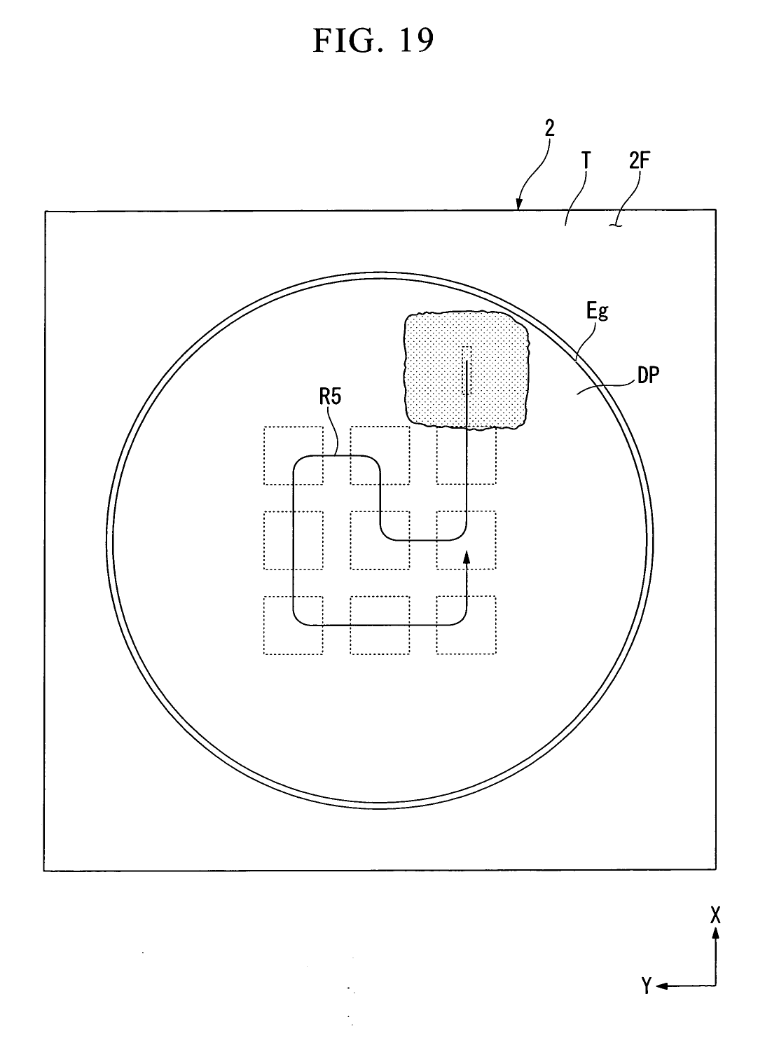

FIG. 18 and FIG. 19 are views that show one example of the locus of movement of the substrate stage 2 during the cleaning operation according to the fourth embodiment. During cleaning, the control apparatus 11 can move the substrate stage 2 with respect to the liquid immersion member 10 such that the immersion space LS is formed on the dummy substrate DP and the substrate stage 2 does not contact the liquid LQ of the immersion space LS. For example, as shown in FIG. 18, during the cleaning operation, the control apparatus 11 can move the liquid immersion member 10 and the dummy substrate DP (i.e., the substrate stage 2) relative to one another such that the immersion space LS moves along an arrow R4. Thereby, at least part of the liquid immersion member 10 is cleaned by the liquid LQ in the immersion space LS.

For example, if there is a possibility that the contact between the edge Eg of the dummy substrate DP and the liquid LQ will produce foreign matter from the vicinity of the edge Eg, then it is possible to prevent foreign matter from being produced by moving the substrate stage 2 with respect to the liquid immersion member 10 such that the immersion space LS is not formed on the edge Eg of the dummy substrate DP held by the substrate stage 2. For example, as shown in FIG. 7, if the dummy substrate DP comprises the base material W, such as a semiconductor wafer, the HMDS film Hd, which is formed on the base material W, and the protective film Tc, which is formed on the HMDS film Hd, and if there is a strong possibility that, for example, part of the protective film Tc in the vicinity of the edge Eg will delaminate owing to contact between the edge Eg of the dummy substrate DP and the liquid LQ, then moving the substrate stage 2 with respect to the liquid immersion member 10 such that the immersion space LS is not formed on the edge Eg of the dummy substrate DP held by the substrate stage 2 makes it possible to prevent foreign matter (i.e., a contaminant) from being produced during the cleaning operation owing to the delamination of the protective film Tc.

In addition, as shown in FIG. 18, the substrate stage 2 is moved such that a hypothetical shot region in the vicinity of the center of the dummy substrate DP is exposed; however, the locus of movement of the substrate stage 2 during the cleaning operation is not limited to that shown in FIG. 18 as long as the immersion space LS is not formed on the edge Eg of the dummy substrate DP. For example, as shown in FIG. 19, it is also possible to move the liquid immersion member 10 and the dummy substrate DP (i.e., the substrate stage 2) by using the control apparatus 11 relative to one another such that the immersion space LS moves along an arrow R5 on the dummy substrate DP during the cleaning operation. In so doing, at least part of the liquid immersion member 10 is cleaned by the liquid LQ of the immersion space LS.

Furthermore, during the cleaning operation, it is also possible to move the substrate stage 2 with respect to the liquid immersion member 10 in the state wherein the immersion space LS is formed on the upper surface 2F of the substrate stage 2 but not on the edge Eg of the dummy substrate DP. Namely, the substrate stage 2 may be moved such that the immersion space LS is moved on the upper surface 2F of the substrate stage 2. Thereby, at least part of the liquid immersion member 10 or at least part of the substrate stage 2, or both, is cleaned by the liquid LQ of the immersion space LS.

The locus of movement of the substrate stage 2 during the cleaning is not limited to the above-described one, and can be appropriately set.

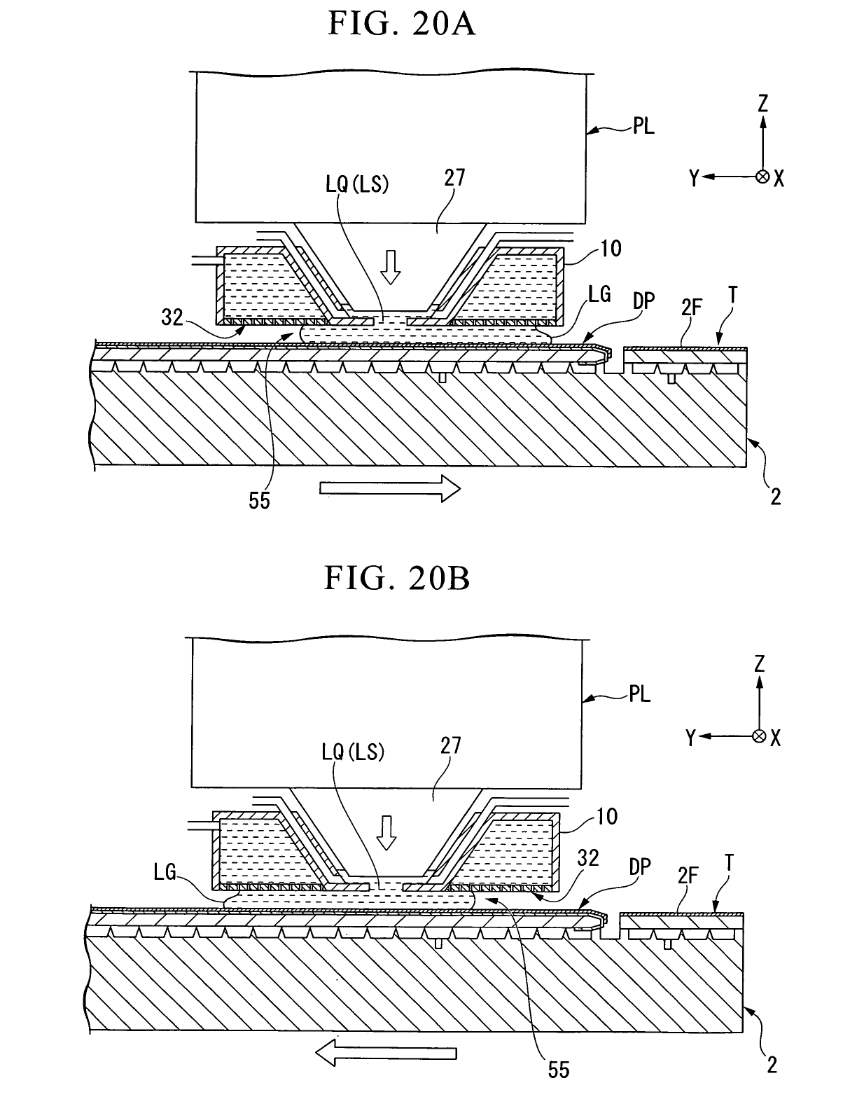

In the first through fourth embodiments discussed above, the control apparatus 11 can set the travel velocity of the substrate stage 2 (i.e., the dummy substrate DP) during at least part of the cleaning higher than that of the substrate stage 2 (i.e., the substrate P) during the exposure of the substrate P. FIGS. 20A and 20B presents schematic drawings that show one example of the state of the immersion space LS for the case wherein the travel velocity of the substrate stage 2 during cleaning is higher than that of the substrate stage 2 during the exposure of the substrate P; therein, FIG. 20A shows the state wherein the substrate stage 2, which holds the dummy substrate DP, moves in the −Y direction with respect to the liquid immersion member 10, and FIG. 20B shows the state wherein the substrate stage 2 moves in the +Y direction with respect to the liquid immersion member 10.

As shown in FIG. 20A, because the substrate stage 2 moves in the −Y direction at a higher speed than it does during the exposure of the substrate P, the interface LG of the liquid LQ of the immersion space LS between the lower surface 32 of the liquid immersion member 10 and the front surface of the dummy substrate DP moves farther in the −Y direction than it does during the exposure of the substrate P. Similarly, as shown in FIG. 20B, because the substrate stage 2 moves in the +Y direction at a higher speed than it does during the exposure of the substrate P, the interface LG of the liquid LQ of the immersion space LS between the lower surface 32 of the liquid immersion member 10 and the front surface of the dummy substrate DP moves farther in the +Y direction than it does during the exposure of the substrate P. The greater amount of movement of the interface LG effectively cleans the lower surface 32 of the liquid immersion member 10 with the liquid LQ of the immersion space LS. Namely, by setting the travel velocity of the substrate stage 2 (i.e., the dummy substrate DP) during at least part of the cleaning greater than that of the substrate stage 2 (i.e., the substrate P) during the exposure of the substrate P such that the contact surface area between the lower surface 32 of the liquid immersion member 10 and the liquid LQ increases, it is possible to effectively clean the lower surface 32 of the liquid immersion member 10.

In addition, the control apparatus 11 can set the linear travel of the substrate stage 2 (i.e., the dummy substrate DP) during at least part of the cleaning greater than that of the substrate stage 2 (i.e., the substrate P) during the exposure of one shot region of the substrate P. The linear travel is defined as the movement of the substrate stage 2 (namely, the object) from a first position to a second position in the XY plane. Increasing the linear travel of the substrate stage 2 (i.e., the dummy substrate DP) during cleaning moves the interface LG of the liquid LQ of the immersion space LS between the lower surface 32 of the liquid immersion member 10 and the front surface of the dummy substrate DP farther than it is moved during the exposure of the substrate P. Increasing the amount of movement of the interface LG effectively cleans the lower surface 32 of the liquid immersion member 10 with the liquid LQ of the immersion space LS. Namely, by setting the linear travel of the substrate stage 2 (i.e., the dummy substrate DP) during at least part of the cleaning greater than that of the substrate stage 2 (i.e., the substrate P) during the exposure of one shot region of the substrate P such that the contact surface area between the lower surface 32 of the liquid immersion member 10 and the liquid LQ increases, it is possible to effectively clean the lower surface 32 of the liquid immersion member 10.

In addition, in the first through fourth embodiments discussed above, the dummy substrate DP, which has a front surface wherein the contact angle of the liquid LQ with respect to that surface is smaller than the contact angle of the liquid LQ with respect to the front surface of the substrate P, may be used. If the dummy substrate DP, which has a front surface wherein the contact angle of the liquid LQ with respect to that surface is smaller than the contact angle of the liquid LQ with respect to the front surface of the substrate P, is used, then the immersion space LS between the lower surface 32 of the liquid immersion member 10 and the front surface of the dummy substrate DP will be greater than it is during the exposure of the substrate P; consequently, the lower surface 32 of the liquid immersion member 10 will be effectively cleaned by the liquid LQ of the immersion space LS. Namely, by using the dummy substrate DP that has a front surface wherein the contact angle of the liquid LQ with respect to that surface is smaller than the contact angle of the liquid LQ with respect to the front surface of the substrate P such that the contact surface area between the lower surface 32 of the liquid immersion member 10 and the liquid LQ increases, it is possible to effectively clean the lower surface 32 of the liquid immersion member 10.

Furthermore, the above text explained an exemplary case wherein the substrate stage 2 (i.e., the dummy substrate DP) moves in the X and Y directions with respect to the liquid immersion member 10; however, if the liquid immersion member 10 were configured movably, then, during cleaning and in the state wherein the immersion space LS were formed, the liquid immersion member 10 would be able to be moved in the X and Y directions with respect to the substrate stage 2 (i.e., the dummy substrate DP), or both the liquid immersion member 10 and the substrate stage 2 (i.e., the dummy substrate DP) would be able to be moved.

### Fifth Embodiment

A fifth embodiment will now be explained. In the explanation below, constituent parts that are identical or equivalent to those in the embodiment discussed above are assigned identical symbols, and the explanations thereof are therefore abbreviated or omitted.

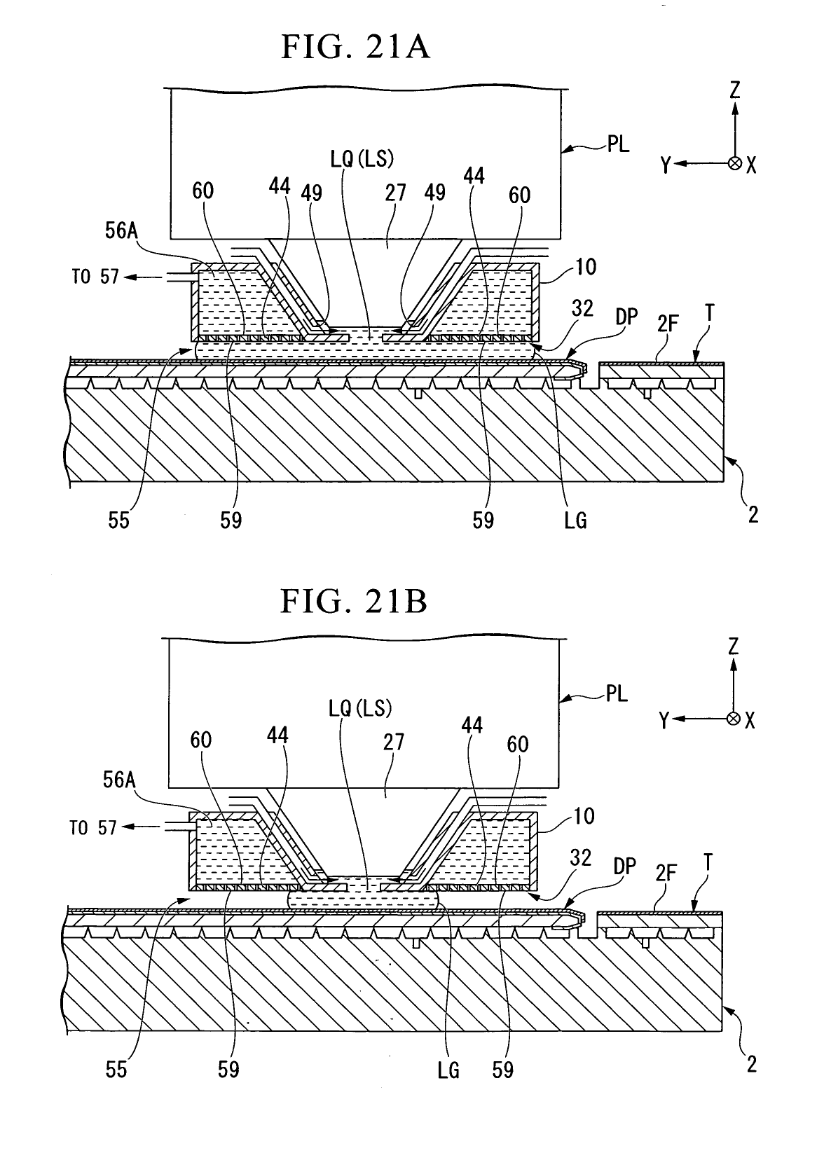

FIGS. 21A and 21B include views that show one example of a cleaning method according to the fifth embodiment. As shown in FIGS. 21A and 21B, in the present embodiment, too, when cleaning is performed, the dummy substrate DP is held by the substrate stage 2 and is disposed at a position at which it opposes the lower surface 32 of the liquid immersion member 10.

During cleaning, the control apparatus 11 controls the operation of supplying the liquid LQ via the supply ports 49 and the operation of adjusting the pressure via the liquid recovery apparatus 57, or both, such that the interface LG of the liquid LQ of the immersion space LS in the first space 55 moves in the radial directions with respect to the optical path of the exposure light EL.

In the present embodiment, the control apparatus 11 moves the interface LG of the liquid LQ of the immersion space LS by maintaining a constant amount of liquid LQ supplied per unit of time from the supply ports 49 to the first space 55 and varying the pressure of the second space 56A. In the present embodiment, as shown in FIG. 21(A), first, the size of the immersion space LS is adjusted such that substantially the entire area of the lower surface 32 of the liquid immersion member 10 (i.e., the lower surface 59 of the porous member 44) contacts the liquid LQ, in other words, such that substantially the entire first space 55 is filled with the liquid LQ. In the present embodiment, the control apparatus 11 sets a substantially constant amount of the liquid LQ to supply per unit of time from the supply ports 49 to the first space 55 and sets the pressure in the second space 56A higher than it is during the exposure of the substrate P. Namely, while supplying per unit of time a substantially constant amount of the liquid LQ to the first space 55, the control apparatus 11 decreases the pressure differential between the lower surface 59 and the upper surface 60 such that it is lower than it is during the exposure of the substrate P (i.e., the control apparatus 11 decreases the liquid recovery force of the porous member 44). Thereby, as shown in FIG. 21(A), the immersion space LS is enlarged at least beyond the size it is during the exposure of the substrate P.

Next, in the state wherein the operation of supplying the liquid LQ from the supply ports 49 to the first space 55 has been performed, the control apparatus 11 increases the pressure differential between the lower surface 59 and the upper surface 60 (i.e., increases the liquid recovery force of the porous member 44) by adjusting the negative pressure in the second space 56A. In the present embodiment, the pressure differential between the lower surface 59 and the upper surface 60 is substantially the same as or greater than the pressure differential during the exposure of the substrate P. Thereby, the liquid LQ moves from the first space 55 to the second space 56A via the porous member 44; furthermore, in the first space 55 as shown in FIG. 21(B), the interface LG of the liquid LQ in the immersion space LS moves such that the size of the immersion space LS decreases.

The control apparatus 11 sets a substantially constant amount of the liquid LQ to be supplied per unit of time to the first space 55 and repetitively performs an operation that switches between the state shown in FIG. 21A and the state shown in FIG. 21B by varying the pressure in the second space 56A while the liquid LQ is being supplied to the first space 55. Thereby, the interface LG of the liquid LQ of the immersion space LS moves in the radial directions with respect to the optical path of the exposure light EL, and the lower surface 32 of the liquid immersion member 10, including the lower surface 59 of the porous member 44, is cleaned satisfactorily.

The enlargement of the immersion space LS such that substantially the entire area of the lower surface 59 of the porous member 44 contacts the liquid LQ as shown in FIG. 21A cleans substantially the entire area of the lower surface 59 satisfactorily. For example, during the exposure of the substrate P, the lower surface 59 potentially includes a first area, which constantly contacts the liquid LQ, and a second area, which repetitively transitions between the state wherein it contacts the liquid LQ and the state wherein it does not. The foreign matter adhered state (i.e., the contamination state) might differ from the first area to the second area. In the present embodiment, both the first area and the second area can be cleaned satisfactorily.

In addition, the control apparatus 11 can move the interface LG of the liquid LQ of the immersion space LS in the radial directions with respect to the optical path of the exposure light EL by controlling the liquid recovery apparatus 57 so as to maintain a substantially constant pressure in the second space 56A and vary the amount of the liquid LQ supplied per unit of time from the supply ports 49 to the first space 55.

For example, the control apparatus 11 would control the liquid recovery apparatus 57 so as to maintain a substantially constant pressure in the second space 56A and set the amount of the liquid LQ supplied per unit of time from the supply ports 49 to the first space 55 greater than it is during the exposure of the substrate P. Thereby, as shown in FIG. 21A, the immersion space LS would be enlarged at least beyond its size during the exposure of the substrate P.

In addition, in the state wherein the pressure of the second space 56A is held substantially constant, the control apparatus 11 would set the amount of the liquid LQ supplied per unit of time from the supply ports 49 to the first space 55 greater than it is during the exposure of the substrate P. Thereby, as shown in FIG. 21B, the interface LG of the liquid LQ of the immersion space LS would move such that the immersion space LS in the first space 55 becomes smaller.

Furthermore, in the first through fourth embodiments, during at least part of the cleaning operation, the operation of supplying the liquid LQ via the supply ports 49 or the operation of adjusting the pressure via the liquid recovery apparatus 57, or both, may be controlled. For example, when the immersion space LS is being moved on the dummy substrate or the substrate stage 2, or both, the operation of supplying the liquid LQ via the supply ports 49 or the operation of adjusting the pressure via the liquid recovery apparatus 57, or both, may be controlled.

In addition, in the explanation above, the dummy substrate DP is both unloaded from the housing apparatus 17 of the exposure apparatus EX and loaded into the housing apparatus 17, but the dummy substrate DP may be loaded from the external apparatus CD into the exposure apparatus EX and unloaded from the exposure apparatus EX into the external apparatus CD.

### Sixth Embodiment

The following text explains a sixth embodiment. In the explanation below, constituent parts that are identical or equivalent to those in the embodiments discussed above are assigned identical symbols, and the explanations thereof are therefore abbreviated or omitted.

The above text explained an exemplary case wherein, during cleaning, the immersion space LS is formed between the liquid immersion member 10 and the substrate stage 2, which holds the dummy substrate DP. The sixth embodiment differs from the first through fifth embodiments in that the immersion space LS is formed between the liquid immersion member 10 and the measurement stage 3, and the liquid immersion member 10 or the measurement stage 3, or both, are cleaned.

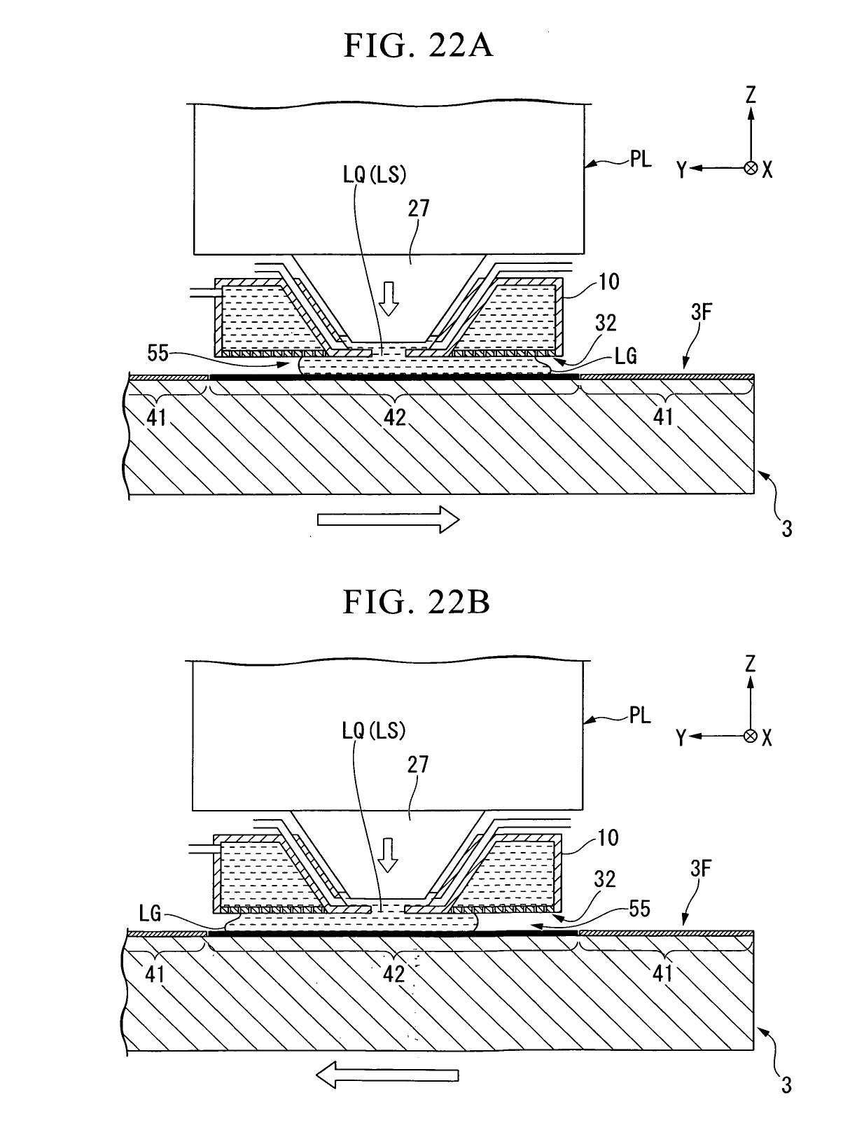

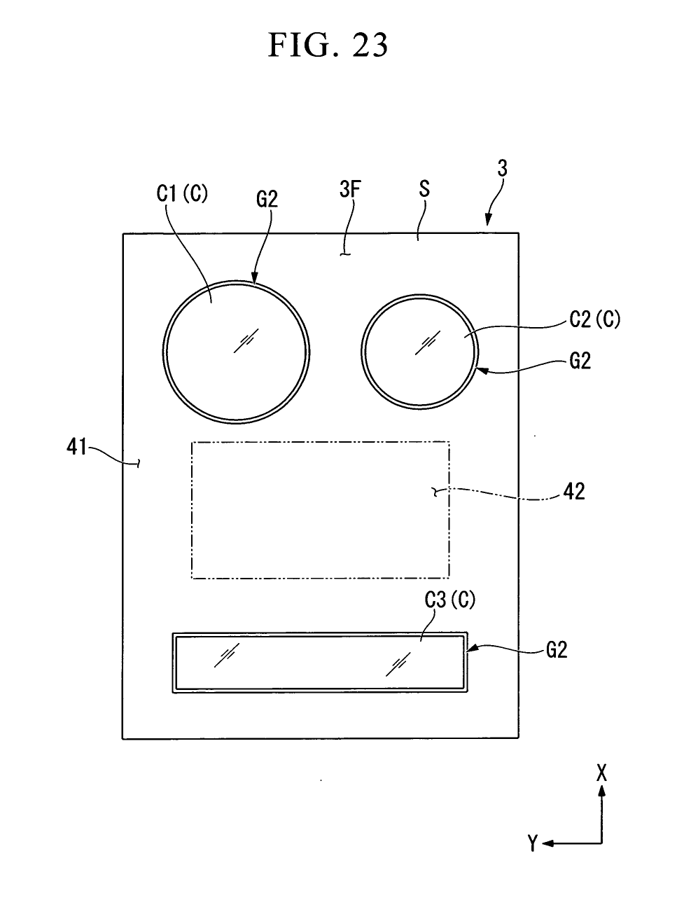

FIGS. 22A and 22B shows one example of a cleaning method according to the sixth embodiment, and FIG. 23 is a plan view of the measurement stage 3 viewed from above. In the present embodiment, as shown in FIG. 23, the upper surface 3F of the measurement stage 3 includes a first area 41, with which the liquid LQ has a first contact angle, and a second area 42, with which the liquid LQ has a second contact angle that is approximately the same as the first contact angle. In the present embodiment, the second contact angle of the liquid LQ with respect to the second area 42 is smaller than the first contact angle of the liquid LQ with respect to the first area. Namely, the second area 42 is more lyophilic with respect to the liquid LQ than is the first area 41. In the present embodiment, the second area 42 is disposed on part of the front surface of the plate member S.

In the present embodiment, during cleaning, the control apparatus 11 forms the immersion space LS with the liquid LQ between the liquid immersion member 10 and the second area 42 of the upper surface 3F of the measurement stage 3. The control apparatus 11 moves the measurement stage 3 with respect to the liquid immersion member 10 in the state wherein the immersion space LS is formed with the liquid LQ between the liquid immersion member 10 and the second area 42 of the upper surface 3F of the measurement stage 3. FIG. 22A shows the state wherein the measurement stage 3 is moving in the −Y direction with respect to the liquid immersion member 10, and FIG. 22B shows the state wherein the measurement stage 3 is moving in the +Y direction with respect to the liquid immersion member 10.

As discussed above, the second contact angle of the liquid LQ with respect to the second area 42 is smaller than the first contact angle of the liquid LQ with respect to the first area 41, and therefore the second area 42 is more lyophilic with respect to the liquid LQ than is the first area 41. As shown in FIG. 22A, by moving the measurement stage 3 in the −Y direction in the state wherein the immersion space LS is formed between the liquid immersion member 10 and the second area 42, the interface LG of the liquid LQ of the immersion space LS between the lower surface 32 of the liquid immersion member 10 and the second area 42 moves farther in the −Y direction than it does in the case wherein the immersion space LS is formed between the lower surface 32 of the liquid immersion member 10 and the first area 41. Similarly, as shown in FIG. 22B, by moving the measurement stage 3 in the +Y direction, the interface LG of the liquid LQ of the immersion space LS between the lower surface 32 of the liquid immersion member 10 and the second area 42 moves farther in the +Y direction than it does in the case wherein the immersion space LS is formed between the lower surface 32 of the liquid immersion member 10 and the first area 41. Increasing the amount of movement of the interface LG effectively cleans at least part of the lower surface 32 of the liquid immersion member 10 or at least part of the upper surface 3F of the measurement stage 3, or both, with the liquid LQ of the immersion space LS. Namely, by forming the immersion space LS with the second area 42 of the upper surface 3F of the measurement stage 3, with which the liquid LQ has a small contact angle, such that the contact surface area between the lower surface 32 of the liquid immersion member 10 and the liquid LQ increases, it possible to effectively clean the lower surface 32 of the liquid immersion member 10.

Furthermore, in the present embodiment, during at least part of the cleaning, the travel velocity of the measurement stage 3 may be set higher than that of the substrate stage 2 (i.e., the substrate P) during an exposure of the substrate P. Alternatively, or in addition thereto, during at least part of the cleaning, the linear travel of the measurement stage 3 may be set greater than that of the substrate stage 2 (i.e., the substrate P) during the exposure of the substrate P. Thereby, the interface LG of the liquid LQ of the immersion space LS between the lower surface 32 of the liquid immersion member 10 and the upper surface 3F of the measurement stage 3 moves farther than it does during the exposure of the substrate P. Accordingly, the lower surface 32 of the liquid immersion member 10 and the upper surface 3F of the measurement stage 3 are effectively cleaned by the liquid LQ of the immersion space LS. Namely, by setting the travel velocity of the measurement stage 3 higher than that of the substrate stage 2 (i.e., the substrate P) during the exposure of the substrate P or setting the linear travel of the measurement stage 3 greater than that of the substrate stage 2 (i.e., the substrate P) during the exposure of the substrate P, or both, such that the contact surface area between the lower surface 32 of the liquid immersion member 10 and the liquid LQ increases, it is possible to effectively clean the lower surface 32 of the liquid immersion member 10.

Furthermore, in the present embodiment, the measurement stage 3, which has the second area 42 wherein the liquid LQ has a small contact angle with respect to that second area 42, is used; however, as in the first through fifth embodiments discussed above, the measurement stage 42 wherein the second area 42 is not formed may be used.

In addition, in the present embodiment, during cleaning, the control apparatus 11 can control the operation of supplying the liquid LQ via the supply ports 49 or the operation of adjusting the pressure via the liquid recovery apparatus 57, or both, such that the interface LG of the liquid LQ of the immersion space LS between the liquid immersion member 10 and the measurement stage 3 moves in the radial directions with respect to the optical path of the exposure light EL.

Furthermore, the present embodiment explained an exemplary case wherein the measurement stage 3 is moved in the X and Y directions with respect to the liquid immersion member 10; however, the liquid immersion member 10 may be configured movably and be moved during cleaning in the X and Y directions with respect to the measurement stage 3 in the state wherein the immersion space LS is formed, or both the liquid immersion member 10 and the measurement stage 3 may be moved.

Furthermore, the cleaning operation of the present embodiment can be used instead of the cleaning operation according to the first embodiment, wherein the dummy substrate DP is used before the start of the process of exposing the lot, or instead of the cleaning operation according to the second embodiment, wherein the cleaning operation is performed before the start of the process of exposing the lot or after the end of the process of exposing the lot, or both. Of course, the cleaning operation wherein the dummy substrate DP is used as discussed above and the cleaning operation wherein the measurement stage 3 is used may be performed in parallel.

In addition, as in the present embodiment, if the dummy substrate DP is not used, then the housing apparatus 17 may be omitted.

Furthermore, in the embodiments discussed above, the optical path on the emergent (i.e., image plane) side of the last optical element 27 of the projection optical system PL is filled with the liquid LQ; however, it is possible to use a projection optical system PL wherein the optical path on the incident (i.e., object plane) side of the last optical element 27 is also filled with the liquid LQ as disclosed in, for example, PCT International Publication No. WO2004/019128.

Furthermore, in each of the embodiments discussed above, water is used as the liquid LQ, but a liquid other than water may be used. It is preferable to use, as the liquid LQ, a liquid that is transparent with respect to the exposure light EL, has a high refractive index with respect to the exposure light EL, and is stable with respect to the projection optical system PL or the film of the photosensitive material (i.e., the photoresist) that forms the front surface of the substrate P. For example, it is also possible to use hydrofluoroether (HFE), perfluorinated polyether (PFPE), Fomblin® oil, or the like as the liquid LQ. In addition, it is also possible to use various fluids, for example, a supercritical fluid, as the liquid LQ.

Furthermore, the substrate P in each of the embodiments discussed above is not limited to a semiconductor wafer for fabricating semiconductor devices, but can also be adapted to, for example, a glass substrate P for display devices, a ceramic wafer for thin film magnetic heads, or the original plate of a mask M or a reticle (i.e., synthetic quartz or a silicon wafer) used by an exposure apparatus EX.

The exposure apparatus EX can also be adapted to a step-and-scan type scanning exposure apparatus (i.e., a scanning stepper) that scans and exposes the pattern of the mask M by synchronously moving the mask M and the substrate P, as well as to a step-and-repeat type projection exposure apparatus (i.e., a stepper) that successively steps the substrate P and performs a full field exposure of the pattern of the mask M with the mask M and the substrate P in a stationary state.

Furthermore, when performing an exposure with a step-and-repeat system, the projection optical system PL is used to transfer a reduced image of a first pattern onto the substrate P in a state wherein the first pattern and the substrate P are substantially stationary, after which, in the state wherein the first pattern and the substrate P are substantially stationary, the projection optical system PL may be used to perform a full-field exposure of the substrate P wherein a reduced image of a second pattern partially superposes the transferred first pattern (as in a stitching type full-field exposure apparatus). In addition, the stitching type exposure apparatus can also be adapted to a step-and-stitch type exposure apparatus that successively steps the substrate P and transfers at least two patterns onto the substrate P such that they are partially superposed.

In addition, the exposure apparatus EX may be an exposure apparatus that combines on the substrate P the patterns of two masks M through the projection optical system PL and double exposes, substantially simultaneously, a single shot region on the substrate P using a single scanning exposure, as disclosed in, for example, U.S. Pat. No. 6,611,316. In addition, the exposure apparatus EX may be a proximity type exposure apparatus, a mirror projection aligner, or the like.

In addition, the exposure apparatus EX may be a twin stage type exposure apparatus, which comprises a plurality of substrate stages, as disclosed in, for example, U.S. Pat. Nos. 6,341,007, 6,208,407, and 6,262,796.

In addition, the exposure apparatus EX may be an exposure apparatus that comprises a plurality of substrate stages and measurement stages.

The type of exposure apparatus EX is also not limited to a semiconductor device fabrication exposure apparatus that exposes the pattern of a semiconductor device on the substrate P, but can be widely adapted to exposure apparatuses used for fabricating, for example, liquid crystal devices or displays, and exposure apparatuses used for fabricating thin film magnetic heads, image capturing devices (CCDs), micromachines (MEMS), DNA chips, or reticles and masks M.

Furthermore, in each of the embodiments discussed above, the position of each of the stages is measured using an interferometer system that comprises laser interferometers, but the present invention is not limited thereto; for example, an encoder system that detects a scale (i.e., diffraction grating) provided to each of the stages may be used.

Furthermore, in the embodiments discussed above, an optically transmissive mask M, wherein a prescribed shielding pattern (or phase pattern or dimming pattern) is formed on an optically transmissive substrate, is used; however, instead of such a mask M, a variable shaped mask (also called an electronic mask, an active mask, or an image generator), wherein a transmissive pattern, a reflective pattern, or a light emitting pattern is formed based on electronic data of the pattern to be exposed, may be used as disclosed in, for example, U.S. Pat. No. 6,778,257. In addition, instead of a variable shaped mask that comprises a non-emissive type image display device, a patterning apparatus that comprises a self luminous type image display device may be provided.

Each of the embodiments discussed above explains an exemplary case of the exposure apparatus EX, which comprises the projection optical system PL; however, an exposure apparatus and an exposing method wherein the projection optical system PL is not used may be adopted. Thus, even if the projection optical system PL were not used, the exposure light EL would be radiated to the substrate P through optical members, such as lenses, and an immersion space would be formed in a prescribed space between the substrate P and such optical members.

In addition, the exposure apparatus EX may be an exposure apparatus (i.e., a lithographic system) that exposes the substrate P with a line-and-space pattern by forming interference fringes on the substrate P, as disclosed in, for example, PCT International Publication No. WO2001/035168.

The exposure apparatus EX according to the embodiments discussed above is manufactured by assembling various subsystems, as well as each constituent element, such that prescribed mechanical, electrical, and optical accuracies are maintained. To ensure these various accuracies, adjustments are performed before and after this assembly, including an adjustment to achieve optical accuracy for the various optical systems, an adjustment to achieve mechanical accuracy for the various mechanical systems, and an adjustment to achieve electrical accuracy for the various electrical systems. The process of assembling the exposure apparatus from the various subsystems includes, for example, the mechanical interconnection of the various subsystems, the wiring and connection of electrical circuits, and the piping and connection of the atmospheric pressure circuit. Naturally, prior to performing the process of assembling the exposure apparatus from these various subsystems, there are also the processes of assembling each individual subsystem. After the process of assembling the exposure apparatus from the various subsystems is complete, a comprehensive adjustment is performed to ensure the various accuracies of the exposure apparatus as a whole. Furthermore, it is preferable to manufacture the exposure apparatus in a clean room, wherein the temperature, the cleanliness level, and the like are controlled.

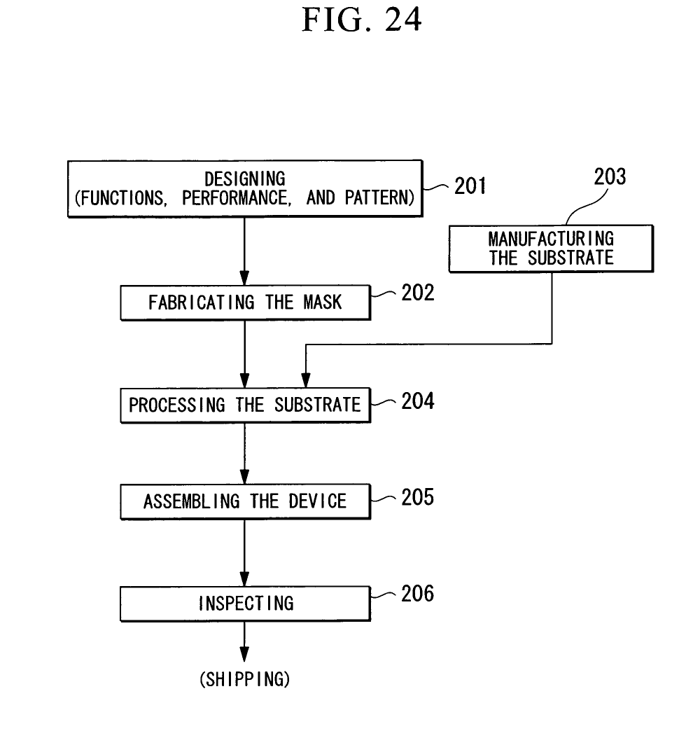

As shown in FIG. 24, a microdevice, such as a semiconductor device, is manufactured by: a step 201 that designs the functions and performance of the microdevice; a step 202 that fabricates a mask M (i.e., a reticle) based on this designing step; a step 203 that manufactures a substrate P, which is the base material of the device; a substrate processing step 204 that comprises a substrate process (i.e., an exposure process) that includes, in accordance with the embodiments discussed above, exposing the substrate P with the exposure light EL using the pattern of the mask M and then developing the exposed substrate P; a device assembling step 205 (which includes fabrication processes such as dicing, bonding, and packaging processes); an inspecting step 206; and the like.

Furthermore, the features (i.e., the technologies) of each of the embodiments discussed above can be combined as appropriate. In addition, there may be cases wherein some of the constituent elements are not used. In addition, each disclosure of every published patent application and U.S. patent related to the exposure apparatus recited in each of the embodiments, modified examples, and the like discussed above is hereby incorporated by reference in its entirety to the extent permitted by national laws and regulations.

What is claimed is:

1. An exposure apparatus that successively exposes each substrate of a plurality of substrates included in a lot with exposure light through a liquid, comprising:
a movable substrate holding member that holds the substrate at a position whereto the exposure light can be radiated; and
a liquid immersion member that is capable of forming an immersion space such that the liquid is held between the liquid immersion member and the substrate held by the substrate holding member and an optical path of the exposure light is filled with the liquid;
wherein, before the start of exposure of a first substrate in the lot, the immersion space is formed between the liquid immersion member and a movable member, which is different from the first substrate, and at least one of the liquid immersion member and the movable member is cleaned.

2. An exposure apparatus according to claim 1, further comprising:
a transport apparatus, which transports the substrate;
wherein, before the first substrate is held by the substrate holding member, the transport apparatus transports a dummy substrate to the substrate holding member; and
the movable member comprises at least one of the substrate holding member and the dummy substrate, which is held by the substrate holding member.

3. An exposure apparatus according to claim 2, wherein
a contact angle of the liquid with respect to a front surface of the dummy substrate is substantially the same as or greater than a contact angle of the liquid with respect to a front surface of the substrate.

4. An exposure apparatus according to claim 2, wherein
during the cleaning, the liquid immersion member and the movable member can move relative to one another.

5. An exposure apparatus according to claim 4, wherein
during the cleaning, the substrate holding member moves with respect to the liquid immersion member such that the immersion space is formed on an edge of the dummy substrate held by the substrate holding member.

6. An exposure apparatus according to claim 5, wherein
during the cleaning, the substrate holding member moves with respect to the liquid immersion member such that the immersion space moves along the edge of the dummy substrate held by the substrate holding member.

7. An exposure apparatus according to claim 4, wherein
a locus of movement of the substrate holding member during the cleaning is substantially the same as a locus of movement of the substrate holding member during the exposure of the substrate.

8. An exposure apparatus according to claim 4, wherein
during the cleaning, the substrate holding member moves with respect to the liquid immersion member such that the immersion space is substantially not formed on the edge of the dummy substrate held by the substrate holding member.

9. An exposure apparatus according to claim 8, wherein
during the cleaning, the substrate holding member is moved with respect to the liquid immersion member such that the immersion space is formed on the dummy substrate and the substrate holding member does substantially not contact the liquid.

10. An exposure apparatus according to claim 1, wherein
during the cleaning, the liquid immersion member and the movable member can move relative to one another.

11. An exposure apparatus according to claim 10, wherein
unlike the substrate holding member, the movable member is movable with respect to the optical path of the exposure light.

12. An exposure apparatus according to claim 11, wherein
the movable member is equipped with a measuring instrument, which measures the exposure light.

13. An exposure apparatus according to claim 4, wherein
a highest value of a travel velocity of the movable member during the cleaning is greater than a highest value of a travel velocity of the substrate holding member during the exposure of the substrate.

14. An exposure apparatus according to claim 4, wherein
a maximum value of a linear travel of the movable member during the cleaning is greater than a maximum value of a linear travel of the substrate holding member during the exposure of the substrate.

15. An exposure apparatus according to claim 4, wherein
the movable member moves with respect to the liquid immersion member while the exposure light is radiated to the movable member through the liquid of the immersion space.

16. An exposure apparatus according to claim 1, wherein
the front surface of the movable member, which is capable of forming the immersion space with the liquid immersion member, includes a first area, wherein the contact angle of the liquid with respect to the first area is a first contact angle, and a second area, wherein the contact angle of the liquid with respect to the second area is a second contact angle that is smaller than the first contact angle; and
during the cleaning, the immersion space is formed between the liquid immersion member and the second area.

17. An exposure apparatus according to claim 1, further comprising:
a detection system, which detects the position of the front surface of the substrate;
wherein the detection system is calibrated in parallel with at least part of the cleaning.

18. An exposure apparatus according to claim 1, wherein
the liquid immersion member has a first surface, which is capable of opposing the movable member, and a second surface, which is on the side of the liquid immersion member opposite that of the first surface, and comprises a porous member, which forms a first space that is capable of holding the liquid between the first surface and the movable member, and a prescribed member, which forms a second space that faces the second surface;
the apparatus further comprising:
a supply port, which is capable of supplying the liquid to the first space;
an adjusting apparatus, which is capable of adjusting a pressure of the second space such that the liquid of the first space is suctioned to the second space through holes of the porous member; and
a control apparatus that, during the cleaning, controls at least one operation selected from the group consisting of the operation of supplying the liquid via the supply port and the operation of adjusting the pressure via the adjusting apparatus such that an interface of the liquid of the immersion space in the first space moves in radial directions with respect to the optical path of the exposure light.

19. An exposure apparatus according to claim 18, wherein
the control apparatus maintains a substantially constant amount of the liquid supplied per unit of time to the first space and varies the pressure of the second space.

20. An exposure apparatus according to claim 18, wherein
the control apparatus maintains a substantially constant pressure in the second space and varies the amount of the liquid supplied per unit of time to the first space.

21. An exposure apparatus according to claim 1, wherein
the cleaning is performed after substantially all of the liquid of the immersion space has been recovered and before the exposure of the first substrate in the lot is started.

22. An exposure apparatus according to claim 21, wherein
the cleaning is performed after the immersion space has been re-formed between the liquid immersion member and the movable member.

23. An exposure apparatus according to claim 1, wherein
after the end of exposure of a last substrate in the lot, the immersion space is formed between the liquid immersion member and the movable member, which is different from the last substrate, and at least one member from the group consisting of the liquid immersion member and the movable member is cleaned.

24. An exposure apparatus that successively exposes each substrate of a plurality of substrates included in a lot with exposure light through a liquid, comprising:
a movable substrate holding member that holds the substrate at a position whereto the exposure light can be radiated; and
a liquid immersion member that is capable of forming an immersion space such that the liquid is held between the liquid immersion member and the substrate held by the substrate holding member and an optical path of the exposure light is filled with the liquid;
wherein, after the end of exposure of a last substrate in the lot, the immersion space is formed between the liquid immersion member and a movable member, which is different from the last substrate, and at least one member from the group consisting of the liquid immersion member and the movable member is cleaned.

25. An exposure apparatus according to claim 23, wherein
after the cleaning after the end of exposure of the last substrate in the lot is complete, substantially all of the liquid is recovered from the immersion space.

26. An exposure apparatus that successively exposes each substrate of a plurality of substrates included in a lot with exposure light through a liquid, comprising:
a movable substrate holding member that holds the substrate at a position whereto the exposure light can be radiated; and
a liquid immersion member that is capable of forming an immersion space such that the liquid is held between the liquid immersion member and the substrate held by the substrate holding member and an optical path of the exposure light is filled with the liquid;
wherein, by moving the substrate holding member such that the immersion space is formed between the substrate held by the substrate holding member and the liquid immersion member and the immersion space is substantially not formed on an edge of the substrate held by the substrate holding member, the liquid immersion member is cleaned.

27. A device fabricating method, comprising of:
exposing a substrate using an exposure apparatus according to claim 1; and
developing the exposed substrate.

28. An exposing method that successively exposes each substrate of a plurality of substrates included in a lot with exposure light through a liquid, the method comprising:
before the start of exposure of a first substrate in the lot, forming an immersion space between a movable member, which is different from the first substrate, and a liquid immersion member such that an optical path of the exposure light is filled with the liquid and cleaning at least one member selected from the group consisting of the liquid immersion member and the movable member; and
after the cleaning, forming the immersion space between the first substrate in the lot and the liquid immersion member such that the optical path of the exposure light is filled with the liquid and starting the exposure of the first substrate.

29. An exposing method according to claim 28, wherein
the movable member comprises at least one member selected from the group consisting of a movable substrate holding member, which holds the substrate at a position whereto the exposure light can be radiated, and a dummy substrate, which is held by the substrate holding member.

30. An exposing method according to claim 28, wherein
the movable member does not hold the substrate and is equipped with a measuring instrument, which measures the exposure light.

31. An exposing method that successively exposes each substrate of a plurality of substrates included in a lot with exposure light through a liquid, the method comprising:
forming an immersion space between a last substrate in the lot and a liquid immersion member such that an optical path of the exposure light is filled with the liquid and exposing the last substrate; and
after the end of exposure of the last substrate, forming the immersion space between a movable member, which is different from the last substrate, and the liquid immersion member and cleaning at least one member selected from the group consisting of the liquid immersion member and the movable member.

32. An exposing method according to claim 31, further comprising:
after the cleaning, recovering substantially all of the liquid from the optical path of the exposure light.

33. A device fabricating method, comprising:
exposing a substrate using an exposing method according to claim 28; and
developing the exposed substrate.
